(19) United States
(12) Patent Application Publication
(10) Pub. No.: US 2025/0230313 A1
(43) Pub. Date: Jul. 17, 2025

(54) ELECTROCONDUCTIVE RESIN COMPOSITION AND CURED PRODUCT THEREOF

(71) Applicant: THREEBOND CO., LTD., Hachioji-shi, Tokyo (JP)

(72) Inventors: Takashi SUZUKI, Hachioji-shi, Tokyo (JP); Takashi NEMOTO, Hachioji-shi, Tokyo (JP)

(21) Appl. No.: 18/854,341

(22) PCT Filed: Apr. 11, 2023
(86) PCT No.: PCT/JP2023/014782

§ 371 Date: Oct. 4, 2024

(30) Foreign Application Priority Data
Apr. 15, 2022 (JP) 2022-067364

(51) Int. Cl. C08L 63/00; C08G 59/40; C08K 3/08; C08K 7/00; C08K 9/04

(52) U.S. Cl. CPC C08L 63/00; C08G 59/4014; C08K 3/08; C08K 7/00; C08K 9/04; C08K 2003/0806; C08K 2201/001; C08K 2201/005; C08K 2201/006; C08K 2201/014; C08K 2201/016; C08L 2205/03; C08L 2207/53

(57) ABSTRACT

According to one embodiment of the present disclosure, an electroconductive resin composition achieves both storage stability and a low connection resistance value of the cured product. An electroconductive resin composition contains the following components (A) to (E), component (A): an epoxy resin having two or more epoxy groups in one molecule, component (B): a reactive diluting agent having one epoxy group in one molecule, component (C): rubber particles, component (D): electroconductive particles containing the following (d-1) and (d-2), (d-1): plate-shaped silver particles, (d-2): electroconductive particles other than plate-shaped silver particles, and component (E): an epoxy curing agent. An organic solvent content is 1% by mass or less with respect to the entire electroconductive resin composition.

### TECHNICAL FIELD

The present invention relates to an electroconductive resin composition that achieves both storage stability and a low connection resistance value of a cured product, and to the cured product thereof.

### BACKGROUND ART

Conventionally, electroconductive resin compositions have been used for purposes such as fixing and earthing electric and electronic components such as smartphones and electronic mobile devices. In recent years, a method of fixing an electronic component by pouring a low-viscosity electroconductive resin composition into the gaps between the electronic components, and the like have become known, and JP 2020-139020 A describes an electroconductive resin composition, in which a solvent is used for making the electroconductive resin composition easier to pour into the gaps between electronic components. In addition, low-resistance electroconductive resins are desired for earthing electronic components in order to easily pass electricity through them, and JP 2016-065146 A describes that an electroconductive resin composition that has excellent conductivity when cured at low temperatures is obtained by the use of plate-shaped silver particles.

### SUMMARY OF INVENTION

However, if resin compositions to cure at low temperatures such as 80° C. contain a solvent, the curing agent dissolves, raising concerns about poor storage stability. In addition, in terms of conductivity, metals such as nickel tend to have poor conductivity because a passive state is formed on the surface, increasing the connection resistance value.

The present invention has been made in consideration of the above circumstances, and an object thereof is to provide an electroconductive resin composition that achieves both excellent storage stability and a low connection resistance value of the cured product. Another object of the present invention is to provide a cured product formed by curing the electroconductive resin composition.

The present inventors have intensively investigated to achieve the above object, and as a result have found a method for producing an electroconductive resin composition that achieves both storage stability and a low connection resistance value of the cured product, thereby completing the present invention.

The gist of the present invention will be described below. One aspect of the present invention for solving the above problems relates to the following electroconductive resin composition.

[1] An electroconductive resin composition containing the following components (A) to (E), wherein an organic solvent content is 1% by mass or less with respect to the entire electroconductive resin composition,
component (A): an epoxy resin having two or more epoxy groups in one molecule,
component (B): a reactive diluting agent having one epoxy group in one molecule,
component (C): rubber particles,
component (D): electroconductive particles containing the following (d-1) and (d-2),
(d-1): plate-shaped silver particles,
(d-2): electroconductive particles other than plate-shaped silver particles, and
component (E): an epoxy curing agent.

The present invention includes, for example, the following aspects and embodiments, but is not limited thereto.

[2] The electroconductive resin composition according to [1], wherein the component (C) is core-shell particles.
[3] The electroconductive resin composition according to [1] or [2], wherein an average particle size of the component (C) is 0.01 to 10 μm.
[4] The electroconductive resin composition according to any one of [1] to [3], wherein an average particle size of each of the (d-1) and the (d-2) is 0.1 to 30 μm.
[5] The electroconductive resin composition according to any one of [1] to [4], wherein the (d-1) and the (d-2) are silver powders surface-treated with stearic acid.
[6] The electroconductive resin composition according to any one of [1] to [5], wherein the (d-1) is single crystalline.
[7] The electroconductive resin composition according to any one of [1] to [6], wherein a mass ratio between the (d-1) and the (d-2) is (d-1): (d-2)=10:90 to 90:10.
[8] The electroconductive resin composition according to any one of [1] to [7], wherein the component (E) is an adduct-type latent curing agent.
[9] The electroconductive resin composition according to any one of [1] to [8], which is used on an adherend with an outermost surface being nickel.

A cured product formed by curing the electroconductive resin composition according to any one of [1] to [9].

### DESCRIPTION OF EMBODIMENTS

The details of the present invention are described below. In the present description, “X to Y” means “X or more and Y or less”, with the numerical values written before and after (X and Y), being included as the lower and upper limits. In the present description, the term “(meth) acrylic” means both acrylic and methacrylic. In addition, unless otherwise specified, concentrations refer to mass concentrations, and ratios refer to mass ratios, unless otherwise specified. In addition, unless otherwise specified, operations and measurements such as physical properties are performed under room temperature (20 to 25° C.) and relative humidity of 40 to 55% RH. In addition, “A and/or B” is meant to include each of A and B, and a combination thereof.

Hereinafter, the embodiments of the present invention will be described, but the present invention is not limited to the following embodiments and can be modified in various ways within the scope of the claims. The embodiments described in the present description can be combined in any way to form other embodiments.

### Electroconductive Resin Composition

One aspect of the present invention relates to an electroconductive resin composition containing the following components (A) to (E), wherein an organic solvent content is 1% by mass or less with respect to the entire electroconductive resin composition,
component (A): an epoxy resin having two or more epoxy groups in one molecule,
component (B): a reactive diluting agent having one epoxy group in one molecule,
component (C): rubber particles,
component (D): electroconductive particles containing the following (d-1) and (d-2),
(d-1): plate-shaped silver particles,
(d-2): electroconductive particles other than plate-shaped silver particles, and
component (E): an epoxy curing agent.

The present aspect can provide an electroconductive resin composition that achieves both excellent storage stability and a low connection resistance value of the cured product. The details of the mechanism by which such an electroconductive resin composition is obtained are unknown, but the present inventors have presumed that the mechanism is as follows. Setting the content of the organic solvent in the electroconductive resin composition to a certain level or less can prevent the component (E) from dissolving in the organic solvent in the electroconductive resin composition and the contact area between the component (E) and the component (A) from increasing, thereby improving the storage stability. Containing (d-1) and (d-2) in the component (D) causes the components (D) to be more likely to come into contact with each other, thereby increasing the number of conductive paths and reducing the connection resistance value of the cured product. Containing the component (B) and the component (C) in the electroconductive resin composition together with the components (A), (D), and (E) reduces the connection resistance value, although the details are unknown. It is a surprising result that the component (B) and the component (C) each contribute to reducing the connection resistance value. The above mechanism is based on presumption, and whether it is correct or not does not affect the technical scope of the present invention.

Each component contained in the electroconductive resin composition will be described below.

### [Component (A)]

The component (A) is an epoxy resin having two or more epoxy groups in one molecule. The component (A) is not particularly limited as long as it is a compound having two or more epoxy groups in one molecule, but in the present description, the component (A) does not include compounds that have two or more epoxy groups and a silicon atom in one molecule, such as compounds that can be used as “silane coupling agents”.

In the compound used as the component (A), the number of epoxy groups contained in one molecule is not particularly limited as long as it is 2 or more. From the viewpoint of excellent curability, in the compound used as the component (A), the number of epoxy groups contained in one molecule is preferably 2 to 6 (di- to hexa-functional epoxy resin), more preferably 2 to 3 (di- to tri-functional epoxy resin), and still more preferably 2 (difunctional epoxy resin). The epoxy group may be contained in the compound (epoxy resin) in the form of a glycidyl group. As one example, the component (A) preferably contains a compound containing 2 to 6 epoxy groups in one molecule (di- to hexa-functional epoxy resin), more preferably contains a compound containing 2 to 3 epoxy groups in one molecule (di- to tri-functional epoxy resin), and still more preferably contains a compound containing 2 epoxy groups in one molecule (difunctional epoxy resin). As another example, the component (A) is preferably a compound containing 2 to 6 epoxy groups in one molecule (di- to hexa-functional epoxy resin), more preferably a compound containing 2 to 3 epoxy groups in one molecule (di- to tri-functional epoxy resin), and still more preferably a compound containing 2 epoxy groups in one molecule (difunctional epoxy resin).

The compound used as the component (A) may be solid or liquid, and its state is not particularly limited, however, in terms of excellent curability and workability, it is preferable that the compound used as the component (A) is liquid. For this reason, it is preferable that the component (A) contains a liquid compound having two or more epoxy groups in one molecule. In the present description, “liquid” means a state having fluidity (liquid state) at 25° C. Specifically, “liquid state at 25° C.” means that the viscosity measured at 25° C. using a cone-plate rotational viscometer at a shear rate of 10 s⁻¹ is 1,000 Pa·s or less. The viscosity of the compound used as the component (A) at 25° C. is preferably 0.01 Pa·s or more and less than 100 Pa·s, more preferably 0.1 to 50 Pa·s, particularly preferably 0.3 to 10 Pa˜s, and still more particularly preferably 0.5 to 5 Pa·s. These viscosities at 25° C. are also values measured at 25° C. using a cone-plate rotational viscometer at a shear rate of 10 s⁻¹. Thus, as one example, the component (A) preferably contains a compound having two or more epoxy groups in one molecule and having a viscosity at 25° C. of 0.01 Pa·s or more and less than 100 Pa·s, more preferably contains a compound having two or more epoxy groups in one molecule and having a viscosity at 25° C. of 0.1 to 50 Pa·s, still more preferably contains a compound having two or more epoxy groups in one molecule and having a viscosity at 25° C. of 0.3 to 10 Pa·s, and particularly preferably contains a compound having two or more epoxy groups in one molecule and having a viscosity at 25° C. of 0.5 to 5 Pa·s. As another example, the component (A) is preferably a compound having two or more epoxy groups in one molecule and having a viscosity of 0.01 Pa·s or more and less than 100 Pa·s at 25° C., more preferably a compound having two or more epoxy groups in one molecule and having a viscosity of 0.1 to 50 Pa·s at 25° C., still more preferably a compound having two or more epoxy groups in one molecule and having a viscosity of 0.3 to 10 Pa·s at 25° C., and particularly preferably a compound having two or more epoxy groups in one molecule and having a viscosity of 0.5 to 5 Pa·s at 25° C.

The epoxy equivalent of the compound used as the component (A) is not particularly limited, but from the viewpoint that curability may be superior, preferably 50 g/eq or more and less than 300 g/eq, more preferably 100 g/eq or more and less than 250 g/eq, and particularly preferably 130 to 230 g/eq. In the present description, the epoxy equivalent is a value measured in accordance with JIS K-7236: 2001. In addition, if the epoxy equivalent cannot be determined by this method, calculation may be performed as a value obtained by dividing the molecular weight of the target epoxy resin (compound) by the number of epoxy groups contained in one molecule of the epoxy resin (compound). Therefore, the component (A) preferably contains a compound having an epoxy equivalent of 50 g/eq or more and less than 300 g/eq and having two or more epoxy groups in one molecule, more preferably contains a compound having an epoxy equivalent of 100 g/eq or more and less than 250 g/eq and having two or more epoxy groups in one molecule, and still more preferably contains a compound having an epoxy equivalent of 130 to 230 g/eq and having two or more epoxy groups in one molecule.

Specific examples of the component (A) are not particularly limited. Specific examples of the component (A) include bisphenol epoxy resins; alkylene glycol epoxy resins such as 1,2-butanediol diglycidyl ether, 1,3-butanediol diglycidyl ether, 1,4-butanediol diglycidyl ether, (poly)ethylene glycol diglycidyl ether, and propylene glycol diglycidyl ether, 2,3-butanediol diglycidyl ether, 1,5-pentanediol diglycidyl ether, 1,6-hexanediol diglycidyl ether, neopentyl glycol diglycidyl ether, and 1,4-cyclohexanedimethanol diglycidyl ether; novolak type epoxy resins such as phenol novolak type epoxy resins and cresol novolak type epoxy resins; glycidylamine compounds such as N,N-diglycidyl-4-glycidyloxyaniline, 4,4′-methylenebis(N,N-diglycidylaniline), tetraglycidyldiaminodiphenylmethane, and tetraglycidyl-m-xylylenediamine; and naphthalene type epoxy resins having four glycidyl groups. These may be used singly or in combination of two or more types. The component (A) preferably contains at least one type selected from the group consisting of a bisphenol type epoxy resin, an alkylene glycol type epoxy resin, a novolak type epoxy resin, a glycidyl amine compound, and a naphthalene type epoxy resin having four glycidyl groups, and more preferably contains at least one type selected from the group consisting of a bisphenol type epoxy resin, an alkylene glycol type epoxy resin, a novolak type epoxy resin, a glycidyl amine compound, and a naphthalene type epoxy resin having four glycidyl groups. As one example, in terms of excellent conductivity of the cured product, the component (A) preferably contains a bisphenol epoxy resin, and is more preferably a bisphenol type epoxy resin.

The content of the bisphenol type epoxy resin in the component (A) is not particularly limited, but is preferably 50% by mass or more, more preferably 90% by mass or more, and still more preferably 95% by mass or more (upper limit 100% by mass) with respect to the total mass of the component (A). If two or more types of epoxy resins are used as the component (A), the content of the component (A) refers to the total amount thereof. If two or more types of epoxy resins are used as the bisphenol type epoxy resin, the content of the bisphenol type epoxy resin refers to the total amount thereof.

The bisphenol type epoxy resin is not particularly limited as long as it is an epoxy resin having a bisphenol skeleton. Examples of the bisphenol type epoxy resin include a bisphenol A type epoxy resin, a bisphenol F type epoxy resin, a bisphenol S type epoxy resin, a bisphenol AD type epoxy resin, a hydrogenated bisphenol A type epoxy resin, a hydrogenated bisphenol F type epoxy resin, a urethane modified bisphenol type epoxy resin, a rubber modified bisphenol type epoxy resin, and a polyoxyalkylene modified bisphenol type epoxy resin. These may be used singly or in combination of two or more types. The bisphenol type epoxy resin preferably contains at least one type selected from the group consisting of the compounds listed above, and more preferably is at least one type selected from the group consisting of the compounds listed above. In terms of excellent conductivity of the cured product and excellent workability, as the bisphenol type epoxy resin, it is preferable to use a combination of bisphenol A type epoxy resin and bisphenol F type epoxy resin. The bisphenol type epoxy resin preferably contains a bisphenol A type epoxy resin and a bisphenol F type epoxy resin, and more preferably is a bisphenol A type epoxy resin and a bisphenol F type epoxy resin.

If the bisphenol type epoxy resin contains a bisphenol A type epoxy resin and a bisphenol F type epoxy resin (preferably, if the bisphenol type epoxy resin is a bisphenol A type epoxy resin and a bisphenol F type epoxy resin), the mass ratio between the bisphenol A type epoxy resin and the bisphenol F type epoxy resin is not particularly limited, but is preferably bisphenol A type epoxy resin:bisphenol F type epoxy resin=1:99 to 99:1, more preferably bisphenol A type epoxy resin:bisphenol F type epoxy resin=1:90 to 50:50, and still more preferably bisphenol A type epoxy resin: bisphenol F type epoxy resin=20:80 to 45:55. If two or more types of epoxy resins are used as the bisphenol A type epoxy resin, the content of the bisphenol A type epoxy resin refers to the total amount thereof. If two or more types of epoxy resins are used as the bisphenol F type epoxy resin, the content of the bisphenol F type epoxy resin refers to the total amount thereof.

As the component (A), a commercially available product and/or a synthetic product may be used. There are no particular limitations on the commercially available bisphenol epoxy resin. Examples of the commercially available bisphenol epoxy resin include jER (registered trademark) 828, 1001, 801, 806, 807, YX8000, YX8034, YX4000 (manufactured by Mitsubishi Chemical Corporation), EPICLON (registered trademark) 830, 850, EXA-830CRP, EXA-830LVP, EXA-850CRP, EXA-835LV (manufactured by DIC Corporation), ADEKA RESIN (registered trademark) EP4100, EP4000, EP4080, EP4085, EP4088, EPU6, EPU7N, EPR4023, EPR1309, EP4920 (manufactured by ADEKA CORPORATION), TEPIC (registered trademark) (manufactured by Nissan Chemical Corporation), KF-101, KF-1001, KF-105, X-22-163B, X-22-9002 (manufactured by Shin-Etsu Chemical Co., Ltd.), Denacol (registered trademark) EX411, 314, 201, 212, 252 (manufactured by Nagase Chemtex Corporation), DER-331, 332, 334, 431, 542 (manufactured by The Dow Chemical Company), and YH-434, YH-434L (manufactured by NIPPON STEEL Chemical & Material Co., Ltd.). In addition, as the component (A), the resin component in Kaneace (registered trademark) MX-153 (KANEKA CORPORATION), the bisphenol A type epoxy resin in Cureduct (registered trademark) L-07N (SHIKOKU CHEMICALS CORPORATION), and the like may be used. These may be used singly or in combination of two or more types.

The component (A) may be a rubber-dispersed epoxy resin. A rubber-dispersed epoxy resin is an epoxy resin in which rubber particles are dispersed. That is, the component (A) may contain an epoxy resin having two or more epoxy groups in one molecule in the rubber-dispersed epoxy resin, or may be an epoxy resin having two or more epoxy groups in one molecule in the rubber-dispersed epoxy resin.

The rubber particles contained in the rubber-dispersed epoxy resin may be particles made of only one layer exhibiting rubber elasticity, or may be particles having a multi-layer structure having at least one layer exhibiting rubber elasticity, or may be a combination thereof. The rubber particles are previously dispersed in the epoxy resin to obtain the rubber-dispersed epoxy resin, and then the rubber-dispersed epoxy resin may be used. In this case, specifically, the rubber particles may be dispersed in the epoxy resin using a mixing and stirring device such as a high-power homogenizer, or the rubber particles may be synthesized in the epoxy resin by emulsion polymerization. The polymer constituting the rubber particles contained in the rubber- dispersed epoxy resin is not particularly limited. Examples of the polymer constituting the rubber particles contained in the rubber-dispersed epoxy resin include butadiene rubber, acrylic rubber, silicone rubber, butyl rubber, olefin rubber, styrene rubber, NBR (nitrile rubber), SBR (styrene butadiene rubber), IR (isoprene rubber), and EPR (ethylene propylene rubber). These may be used singly or may be used in a combination of two or more types. The rubber particles contained in the rubber-dispersed epoxy resin preferably contain rubber particles containing at least one type of a polymer selected from the group consisting of the polymers listed above, and are preferably rubber particles containing at least one type of a polymer selected from the group consisting of the polymers listed above. As one example, the rubber particles contained in the rubber-dispersed epoxy resin preferably contain rubber particles containing butadiene rubber, rubber particles containing acrylic rubber, or a combination thereof, and are preferably rubber particles containing butadiene rubber, rubber particles containing acrylic rubber, or a combination thereof. As another example, the rubber particles contained in the rubber-dispersed epoxy resin preferably contain rubber particles containing butadiene rubber, and more preferably are rubber particles containing butadiene rubber. The rubber particles containing butadiene rubber are not particularly limited. Examples of the rubber particles containing butadiene rubber include rubber particles having a core-shell structure and containing butadiene rubber.

In the present description, the rubber particles in the rubber-dispersed epoxy resin are treated as the component (C) described below. Thus, an electroconductive resin composition may be produced by mixing a rubber-dispersed epoxy resin containing an epoxy resin having two or more epoxy groups in one molecule (i.e., a composition containing the component (A) and the component (C) described below), the component (B) described below, the component (D) described below, the component (E) described below, and, as necessary, an optional component described below.

As the rubber-dispersed epoxy resin, a commercially available product and/or a synthetic product may be used. The commercially available rubber-dispersed epoxy resin is not particularly limited. Examples of the commercially available rubber-dispersed epoxy resin include Kane Ace (registered trademark) MX-153, MX-136, MX-257, MX-127, and MX-451 (manufactured by KANEKA CORPORATION), and Acryset (registered trademark) BPF-307, and BPA-328 (manufactured by NIPPON SHOKUBAI co., LTD.). These may be used singly, or may be used in a combination of two or more types.

As the component (A), one type of epoxy resin may be used, or two or more types of epoxy resins may be used in combination.

### [Component (B)]

The component (B) is a reactive diluting agent having one epoxy group in one molecule (also referred to simply as “reactive diluting agent” in the present description). The reason is not clear, but adding a reactive diluting agent can not only adjust the viscosity, but also reduce the connection resistance value of the cured product, thus allowing to obtain an electroconductive resin composition having low viscosity and favorable conductivity of the cured product. The component (B) is not particularly limited as long as it is a compound having one epoxy group in one molecule, but the component (B) does not include a compound having one epoxy group and a silicon atom in one molecule, such as a compound that can be used as a “silane coupling agent” described below. The epoxy group may be contained in the compound (epoxy resin) in the form of a glycidyl group.

From the viewpoint of superior workability, the viscosity of the compound used as the component (B) at 25° C. is not particularly limited, but is preferably 1 to 500 mPa·s, more preferably 3 to 100 mPa·s, and still more preferably 5 to 50 mPa·s. The viscosity of the compound used as the component (B) at 25° C. can be measured at 25° C. using a cone-plate rotational viscometer at a shear rate of 10 s⁻¹. Thus, as one example, the component (B) preferably contains a compound having one epoxy group in one molecule and having a viscosity of 1 to 500 mPa·s at 25° C., more preferably contains a compound having one epoxy group in one molecule and having a viscosity of 3 to 100 mPa·s at 25° C., and still more preferably contains a compound having one epoxy group in one molecule and having a viscosity of 5 to 50 mPa·s at 25° C. As another example, the component (B) is preferably a compound having one epoxy group in one molecule and having a viscosity of 1 to 500 mPa·s at 25° C., more preferably a compound having one epoxy group in one molecule and having a viscosity of 3 to 100 mPa·s at 25° C., and still more preferably a compound having one epoxy group in one molecule and having a viscosity of 5 to 50 mPa·s at 25° C.

From the viewpoint of excellent reactivity and that it may be possible to suppress generation of outgas, the epoxy equivalent of the compound used as the component (B) is not particularly limited, but is preferably 100 to 500 g/eq, more preferably 150 to 350 g/eq, and still more preferably 200 to 300 g/eq. As one example, the component (B) preferably contains a compound having an epoxy equivalent of 100 to 500 g/eq and having one epoxy group in one molecule, more preferably contains a compound having an epoxy equivalent of 150 to 350 g/eq and having one epoxy group in one molecule, and still more preferably contains a compound having an epoxy equivalent of 200 to 300 g/eq and having one epoxy group in one molecule. As another example, the component (B) is preferably a compound having an epoxy equivalent of 100 to 500 g/eq and having one epoxy group in one molecule, more preferably a compound having an epoxy equivalent of 150 to 350 g/eq and having one epoxy group in one molecule, and still more preferably a compound having an epoxy equivalent of 200 to 300 g/eq and having one epoxy group in one molecule.

The reactive diluting agent is not particularly limited. Examples of the reactive diluting agent include glycidyl ethers such as methyl glycidyl ether, ethyl glycidyl ether, butyl glycidyl ether, isobutyl glycidyl ether, phenyl glycidyl ether, 2-ethylhexyl glycidyl ether, decyl glycidyl ether, stearyl glycidyl ether, allyl glycidyl ether, 2-methyloctyl glycidyl ether, methoxypolyethylene glycol monoglycidyl ether, ethoxypolyethylene glycol monoglycidyl ether, butoxypolyethylene glycol monoglycidyl ether, phenoxypolyethylene glycol monoglycidyl ether, p-tertiarybutylphenyl glycidyl ether, sec-butylphenyl glycidyl ether, n-butylphenyl glycidyl ether, phenylphenol glycidyl ether, cresyl glycidyl ether, and dibromocresyl glycidyl ether; and glycidyl esters such as neodecanoic acid glycidyl ester. These may be used singly or in combination of two or more types. From the viewpoints of being superior in storage stability and conductivity of the cured product, the component (B) preferably contains glycidyl ether, glycidyl ester, or a combination thereof, more preferably contains glycidyl ester, and still more preferably contains neodecanoic acid glycidyl ester. As another example, from the viewpoints of being superior in storage stability and conductivity of the cured product, the component (B) is preferably glycidyl ester, glycidyl ether, or a combination thereof, more preferably glycidyl ester, and still more preferably neodecanoic acid glycidyl ester.

As the component (B), a commercially available product and/or a synthetic product may be used. Examples of the commercially available product of the component (B) include EPIOL (registered trademark) TB manufactured by NOF Corporation and CARDURA E10P manufactured by Momentive Performance Materials, but the commercially available product of the component (B) is not limited to these.

As the component (B), one type of reactive diluting agent may be used, or two or more types of reactive diluting agents may be used in combination.

The content of the component (B) is preferably 10 to 50 parts by mass, more preferably 15 to 45 parts by mass, and still more preferably 20 to 40 parts by mass, with respect to 100 parts by mass of the component (A). The content of the component (B) is 10 parts by mass or more with respect to 100 parts by mass of the component (A), thereby allowing to obtain an electroconductive resin composition having excellent connection resistance value of the cured product. The content of the component (B) is 50 parts by mass or less with respect to 100 parts by mass of the component (A), thereby allowing to obtain an electroconductive resin composition having excellent storage stability. If two or more types of epoxy resins are used as the component (A), the content of the component (A) refers to the total amount thereof. If two or more types of reactive diluting agents are used as the component (B), the content of the component (B) refers to the total amount thereof.

### <Component (C)>

The component (C) is rubber particles. In the present description, rubber particles are particles that contain a layer that exhibits rubber elasticity. The rubber particles may be particles made of only one layer that exhibits rubber elasticity, or core-shell particles that are multi-layered particles having at least one layer that exhibits rubber elasticity, or combination of these. The reason is unclear, but core-shell particles are preferable because of having excellent resin resistance (also called volume resistivity of the cured product). As one example, the rubber particles preferably contain core-shell particles, and are more preferably core-shell particles. As described above, rubber particles that have been dispersed previously in the epoxy resin (the component (A)) may be used as the component (C). The polymer constituting the rubber particles is not particularly limited. Examples of the polymer constituting the rubber particles include butadiene rubber, acrylic rubber, silicone rubber, butyl rubber, olefin rubber, styrene rubber, NBR (nitrile rubber), SBR (styrene butadiene rubber), IR (isoprene rubber), and EPR (ethylene propylene rubber). These may be used singly or in combination of two or more. The component (C) preferably contains rubber particles containing at least one type of a polymer selected from the group consisting of the polymers listed above, and more preferably is rubber particles containing one type of a polymer selected from the group consisting of the polymers listed above. As one example, the component (C) preferably contains rubber particles containing butadiene rubber, rubber particles containing acrylic rubber, or a combination thereof, preferably is rubber particles containing butadiene rubber, rubber particles containing acrylic rubber, or a combination thereof. The rubber particles containing butadiene rubber are not particularly limited. Examples of the rubber particles containing butadiene rubber include rubber particles having a core-shell structure and containing butadiene rubber. The rubber particles containing acrylic are rubber not particularly limited. Examples of the rubber particles containing acrylic rubber include rubber particles having a core-shell structure and containing acrylic rubber. The “acrylic rubber” is preferably a rubber consisting of a (co)polymer of a monomer containing a (meth)acrylic acid ester, and more preferably is a rubber consisting of a (co)polymer of a (meth)acrylic acid ester.

Core-shell particles are fine particles in which the core (nucleus) and shell (wall) of the particles consist of polymers with different properties. One example of a preferred method for producing core-shell particles (powder particles) includes the following method, but the method for producing core-shell particles is not limited thereto.

First, polymer particles are produced by polymerizing a polymerizable monomer as the core portion. Examples of this polymerizable monomer (polymerizable monomer used to obtain the core portion) include butadiene; (meth)acrylate monomers such as (meth)acrylate, n-butyl (meth)acrylate, 2-ethylhexyl n-propyl (meth)acrylate, n-decyl (meth)acrylate, 2-hydroxyethyl (meth)acrylate, 3-hydroxybutyl (meth)acrylate, and butoxyethyl methacrylate; aromatic vinyl compounds such as styrene, vinyl toluene, and α-methylstyrene; vinyl cyanide compounds such as acrylonitrile, methacrylonitrile, and vinylidene cyanide; 2-hydroxyethyl fumarate, hydroxybutyl vinyl ether, and monobutyl maleate. Further, examples of the polymerizable monomer include cross-linking monomers having two or more reactive groups such as ethylene glycol di(meth)acrylate, butylene glycol di(meth)acrylate, trimethylolpropane di(meth)acrylate, trimethylolpropane tri(meth)acrylate, hexanediol di(meth)acrylate, hexanediol tri(meth)acrylate, oligoethylene di(meth)acrylate, and oligoethylene tri(meth)acrylate; aromatic divinyl monomers such as divinylbenzene; triallyl trimellitate, and triallyl isocyanelate. However, the polymerizable monomer used to obtain the core portion is not limited thereto. For the polymerizable monomer used to obtain the core portion, one type or two or more different types can be selected and used. The polymerizable monomer used to obtain the core portion preferably contains at least one type selected from the group consisting of butadiene, a (meth)acrylate monomer, an aromatic vinyl compound, a cyanide vinyl compound, 2-hydroxyethyl fumarate, hydroxybutyl vinyl ether, monobutyl maleate, a crosslinkable monomer having two or more reactive groups, an aromatic divinyl monomer, triallyl trimellitate, and triallyl isocyanelate, and more preferably is at least one type selected from the group consisting of butadiene, a (meth)acrylate monomer, an aromatic vinyl compound, a cyanide vinyl compound, 2-hydroxyethyl fumarate, hydroxybutyl vinyl ether, monobutyl maleate, a crosslinkable monomer having two or more reactive groups, an aromatic divinyl monomer, triallyl trimellitate, and triallyl isocyanelate.

Then, the thus obtained polymer particles are used as the core, and further a second polymerization is performed to polymerize a polymerizable monomer to form a shell consisting of a polymer having a melting point equal to or higher than room temperature. The polymerizable monomer used in this case (polymerizable monomer used to obtain the shell portion) can be selected from the same polymerizable monomers listed as examples of the polymerizable monomers used to provide the core (polymerizable monomers used to obtain the core portion) described above. Preferable examples of a polymerizable monomer used as a shell material (polymerizable monomers used to obtain the shell portion) include (meth)acrylates with an alkyl group of 1 to 4 carbon atoms (i.e., (meth)acrylic acid alkyl esters with an alkyl group bonded to a (meth)acryloyloxy group having 1 to 4 carbon atoms), such as ethyl (meth)acrylate, n-butyl acrylate, methyl methacrylate, and butyl methacrylate. In the present description, the (meth)acryloyloxy group means both an acryloyloxy group and a methacryloyloxy group. For the polymerizable monomer used to obtain the shell portion, one type or two or more different types can be selected and used. As one example, the polymerizable monomer used as the shell material preferably contains a (meth)acrylate having an alkyl group with 1 to 4 carbon atoms, and more preferably is a (meth)acrylate having an alkyl group with 1 to 4 carbon atoms. As another example, the polymerizable monomer used as the shell material preferably contains at least one type selected from the group consisting of ethyl (meth)acrylate, n-butyl acrylate, methyl methacrylate, and butyl methacrylate, and more preferably is at least one type selected from the group consisting of ethyl (meth)acrylate, n-butyl acrylate, methyl methacrylate, and butyl methacrylate.

It is preferable that the polymerizable monomer used to obtain the core portion is different from the polymerizable monomer used to obtain the shell portion. That is, in the core-shell particles, it is preferable that the polymer constituting the core is different from the polymer constituting the shell. The core-shell particles preferably contain core-shell particles containing butadiene rubber, core-shell particles containing acrylic rubber, or a combination thereof, and more preferably are core-shell particles containing butadiene rubber, core-shell particles containing acrylic rubber, or a combination thereof. Examples of the core-shell particles containing butadiene rubber include particles containing a polymer obtained from one or more monomers containing butadiene in the core layer and/or shell layer. Examples of the rubber particles containing acrylic rubber include rubber particles containing a polymer obtained from one or more monomers containing a (meth)acrylate monomer in the core layer and/or shell layer.

As the component (C), a commercially available product and/or a synthetic product may be used. The core-shell particles used as the component (C) may be synthesized, for example, by the method described above, but the commercially available product may also be used, or these may be used in combination. There is no particular limitation on the commercially available core-shell particles. Examples of the commercially available core-shell particles that can be used include Paraloid EXL-2655 (manufactured by KUREHA CORPORATION) made of butadiene-alkyl methacrylate-styrene copolymer, Staphyloid (registered trademark) AC-3355, Staphyloid (registered trademark) AC3364, Staphyloid (registered trademark) TR-2105, Staphyloid (registered trademark) TR-2102, Staphyloid (registered trademark) TR-2122, Staphyloid (registered trademark) IM-101, Staphyloid (registered trademark) IM-203, Staphyloid (registered trademark) IM-301, Stafiloid (registered trademark) IM-401 and Stafiloid (registered trademark) IM-406, which are made of acrylic acid ester-methacrylic acid ester copolymer, Stafiloid (registered trademark) IM-601 made of acrylic acid ester-acrylonitrile-styrene copolymer, Zefiac F-351G (manufactured by Aica Kogyo Co., Ltd.), Paraloid EXL-2314, EXL-2611, and EXL-3387 (manufactured by Dow Chemical Japan Limited), which are made of polymethacrylic acid ester-based polymer. In addition, as the component (C), rubber particles in Kane Ace (registered trademark) MX-153 (manufactured by KANEKA CORPORATION) may be used. These may be used singly or in combination of two or more types. The core-shell particles are not particularly limited, but from the viewpoint of being effective even with a small amount added, for example, rubber particles having a core-shell structure and containing butadiene rubber, and rubber particles having a core-shell structure and containing acrylic rubber are preferable. From the viewpoint of being effective even with a small amount added, the core-shell particles are preferably (meth)acrylic acid ester-based core-shell particles of such as an acrylic acid ester-methacrylic acid ester copolymer or a polymethacrylic acid ester-based polymer, wherein at least a part of the particles is composed of poly(meth)acrylic acid ester (preferably, 50% by mass or more with respect to the total mass of the particles is composed of poly(meth)acrylic acid ester, more preferably 99% by mass or more with respect to the total mass of the particles is composed of poly(meth)acrylic acid ester, and still more preferably whole of the particles is composed of poly(meth)acrylic acid ester).

As one example, the component (C) preferably contains rubber particles having a core-shell structure and containing butadiene rubber, rubber particles having a core-shell structure and containing acrylic rubber (preferably, (meth)acrylic acid ester-based core-shell particles), or a combination thereof, and more preferably is rubber particles having a core-shell structure and containing butadiene rubber, rubber particles having a core-shell structure and containing acrylic rubber (preferably, (meth)acrylic acid ester-based core-shell particles), or a combination thereof. As another example, the component (C) preferably contains rubber particles having a core-shell structure and containing butadiene rubber, and more preferably is rubber particles having a core-shell structure and containing butadiene rubber.

The average particle size of the component (C) is not particularly limited, but is preferably 0.01 to 10 μm, and more preferably 0.05 to 5 μm. The average particle size of the component (C) is 0.01 μm or more, thereby allowing to obtain an electroconductive resin composition with suppressed increase in viscosity. The average particle size of the component (C) is 10 μm or less, thereby allowing to obtain an electroconductive resin composition with excellent conductivity of the cured product. The average particle size of the component (C) is the particle size at a cumulative volume ratio of 50% (D50) in the particle size distribution determined by a laser diffraction scattering method. As one example, the average particle size of the component (C) can be measured by a laser diffraction scattering type shape distribution measuring instrument.

As the component (C), one type of rubber particles may be used, or two or more types of rubber particles may be used in combination.

The content of the component (C) is not particularly limited, but is preferably 0.01 to 20 parts by mass, more preferably 0.05 to 10 parts by mass, still more preferably 0.09 to 8 parts by mass, and particularly preferably 0.1 to 8 parts by mass, with respect to 100 parts by mass of the component (A). The content of the component (C) is 0.01 parts by mass or more with respect to 100 parts by mass of the component (A), thereby allowing to obtain an electroconductive resin composition having excellent conductivity of the cured product, such as connection resistance value and volume resistivity. The content of the component (C) is 20 parts by mass or less with respect to 100 parts by mass of the component (A), thereby allowing to obtain an electroconductive resin composition with suppressed increase in viscosity. If two or more types of epoxy resins are used as the component (A), the content of the component (A) refers to the total amount thereof. In addition, if two or more types of rubber particles are used as the component (C), the content of the component (C) refers to the total amount thereof.

### [Component (D)]

The component (D) is electroconductive particles containing (d-1) and (d-2). (d-1) is plate-shaped silver particles, and (d-2) is electroconductive particles other than plate-shaped silver particles. By using these in combination, an electroconductive resin composition that has excellent conductivity of the cured product, such as connection resistance value and volume resistivity can be obtained.

((d-1): Plate-shaped Silver Particles)

The plate-shaped silver particles (d-1) can be produced by a known production method. The production method of the plate-shaped silver particles (d-1) is not particularly limited. Examples of the production method of the plate-shaped silver particles (d-1) include the production method shown in JP 2014-196527 A (corresponding to the specification of US 2016/0001362). (d-1) is generally plate-shaped (plate-like) flaky particles having a substantially (approximately or completely) uniform thickness and a silver particle with a smooth surface. That is, (d-1) is silver particles having a plate-shaped (plate-like) shape with a substantially (approximately or completely) uniform thickness and a smooth surface. Examples of the shape of (d-1) generally include polygonal plate shapes such as a triangular plate shape, a truncated triangular plate shape, a quadrangular plate shape, a pentagonal plate shape, and a hexagonal plate shape, but the shape of (d-1) is not limited to these.

The shape and surface condition of the particles can be confirmed by common techniques such as scanning electron microscopy (SEM). When observing a particle with a scanning electron microscope (SEM), it can be determined that the particle is a plate-shaped particle when it is visually confirmed in the SEM image that the particle has a plate-shaped (plate-like) shape, the thickness, which is the distance between the top and bottom surfaces (two bottom surfaces) of the plate-shaped (plate-like) shape, is substantially (approximately or completely) uniform within one particle, and the bottom surface of the plate-shaped (plate-like) shape is substantially (approximately or completely) smooth. In plate-shaped particles, when an SEM image is visually observed, the top and bottom surfaces (two bottom surfaces) of the plate-shaped (plate-like) shape are substantially (approximately or completely) parallel. In the present description, the plate-shaped (plate-like) shape does not include a plate-shaped shape with a clearly curved bottom surface (curved plate-like). Therefore, in the present description, plate-shaped silver particles do not include curved plate-shaped silver particles.

The thickness variation of (d-1) is not particularly limited. In one embodiment, the thickness variation of (d-1) is preferably within a range of ±10% of the thickness of the powder (plate-shaped silver particles), and more preferably within a range of ±5%. The thickness variation of (d-1) is determined by measuring the thickness at three points per one plate-shaped silver particle (one particle) using a scanning electron microscope (SEM) and calculating the average value.

The arithmetic average roughness Ra of the surface of (d-1) is not particularly limited. In one embodiment, the arithmetic average roughness Ra of the surface of (d-1) is preferably 10.0 nm or less, more preferably 8.0 nm or less, and still more preferably 3.5 nm or less (lower limit 0 nm). The arithmetic average roughness Ra of the surface of (d-1) is preferably 1.0 nm or more. Preferable examples of the range of the arithmetic average roughness of the surface of (d-1) include, but are not limited to, 1.0 nm or more and 10.0 nm or less, 1.0 nm or more and 8.0 nm or less, and 1.0 nm or more and 3.5 nm or less. In the present description, the arithmetic average roughness Ra of the surface of (d-1) can be evaluated using an atomic force microscope (AFM). One example of a method for measuring the arithmetic average roughness Ra of the surface of (d-1) includes the method described in paragraphs “0023” to “0025” of JP 2014-196527 A (corresponding to the specification of US 2016/0001362). More specifically, one example of a method for measuring the arithmetic average roughness Ra of the surface of (d-1) includes a method in which, using a scanning probe microscope SPM-9600 manufactured by SHIMADZU CORPORATION, for example, for each 10 randomly selected particles, the arithmetic average roughness is measured at a measurement distance of 2 μm on the flattest surface (when it is difficult to measure throughout a distance of 2 μm on the flattest surface, the largest possible distance on the surface) under the following measurement conditions, the average of the 10 arithmetic average roughnesses is calculated, and the calculated value is taken as the arithmetic average roughness Ra of the surface of (d-1).

### Measurement Conditions

Mode: contact mode
Cantilever: OMCL-TR800PSA-1, manufactured by OLYMPUS CORPORATION
Resolution: 512×512 pixels
Height-direction resolution: 0.01 nm
Traverse direction resolution: 0.2 nm

It is preferable that (d-1) is single crystalline. A single crystal refers to a crystal in which single atoms or molecules are disposed regularly in the same direction. When (d-1) is single crystalline, an electroconductive resin composition having excellent conductivity of the cured product, such as connection resistance value and volume resistivity can be obtained. It is preferable that (d-1) contains single crystal plate-shaped silver particles, and it is more preferable that (d-1) is single crystal plate-shaped silver particles.

(d-1) is preferably particles obtained by largely growing one metal crystal face.

(d-1) may be surface-treated with a lubricant. (d-1) preferably contains plate-shaped silver particles surface-treated with a lubricant, and more preferably is plate-shaped silver particles surface-treated with a lubricant. The lubricant is not particularly limited. As the lubricant, for example, a saturated fatty acid and/or an unsaturated fatty acid can be used. As the lubricant, it is preferable to contain at least one type selected from the group consisting of a saturated fatty acid and an unsaturated fatty acid, and it is preferable to be at least one type selected from the group consisting of a saturated fatty acid and an unsaturated fatty acid. Examples of the lubricant include capric acid, undecylic acid, lauric acid, tridecylic acid, myristic acid, pentadecylic acid, palmitic acid, margaric acid, stearic acid, linolenic acid, linoleic acid, palmitoleic acid, and oleic acid, but stearic acid is preferable in terms of excellent dispersibility and storage stability. These may be used singly or in combination of two or more. The lubricant preferably contains at least one type selected from the group consisting of the compounds listed above, and more preferably is at least one type selected from the group consisting of the compounds listed above. As one example, the lubricant preferably contains stearic acid, and more preferably is stearic acid.

The average particle size of (d-1) is not particularly limited, but is preferably 0.1 μm or more and less than 1,000 μm, more preferably 0.1 to 30 μm, still more preferably 0.1 to 20 μm, particularly preferably 0.3 to 15 μm, and still more particularly preferably 4.0 to 15.0 μm. If the average particle size of (d-1) is 0.1 μm or more, the increase in viscosity can be further suppressed, and the workability is more excellent. If the average particle size of (d-1) is less than 1,000 μm, or even 30 μm or less, an electroconductive resin composition having more excellent conductivity of the cured product can be obtained. Herein, the average particle size of (d-1) is the particle size (D50) at a cumulative volume ratio of 50% in the particle size distribution obtained by a laser diffraction scattering method. As one example, the average particle size of (d-1) can be measured by a laser diffraction scattering type shape distribution measuring instrument.

The thickness (average thickness, T) of (d-1) is not particularly limited, but from the viewpoint of obtaining superior conductivity of the cured product, it is preferably 1 nm or more and less than 1000 nm, more preferably 10 to 200 nm, still more preferably 30 to 150 nm, and particularly preferably 60 to 100 nm. The thickness (average thickness, T) of (d-1) can be confirmed using a scanning electron microscope (SEM). More specifically, the thickness is obtained by randomly selecting 100 plate-shaped silver particles, measuring the thickness of each, and calculating the average value. The thickness of each plate-shaped silver particle is measured based on an SEM image.

The aspect ratio of (d-1) is not particularly limited, but from the viewpoint of obtaining a cured product with superior conductivity, it is preferably 5 or more, more preferably 5 to 100, still more preferably 10 to 75, and particularly preferably 10 to 60. The aspect ratio of (d-1) can be calculated by (average particle size)/(thickness) from the average particle size obtained by a laser diffraction scattering type shape distribution measuring instrument and the thickness (average thickness, T) confirmed using a scanning electron microscope (SEM).

The specific surface area of (d-1) is not particularly limited. In one embodiment, the specific surface area of (d-1) is preferably 0.1 to 7.0 m²/g, more preferably 0.3 to 5.0 m²/g, still more preferably 0.5 to 3.0 m²/g, particularly preferably 0.50 to 3.00 m²/g, and still more particularly preferably 1.00 to 3.00 m²/g. If the specific surface area of (d-1) is 0.1 m²/g or more, an electroconductive resin composition having excellent conductivity of the cured product can be obtained. If the specific surface area of (d-1) is 7.0 m²/g or less, an electroconductive resin composition having excellent workability can be obtained. In another embodiment, the specific surface area of (d-1) is preferably 0.50 m²/g or more, more preferably 0.50 to 7.00 m²/g, still more preferably 0.50 to 5.00 m²/g, still more preferably 0.50 to 3.00 m²/g, and particularly preferably 0.90 to 3.00 m²/g. The specific surface area herein is a value calculated by the BET method.

As (d-1), a synthetic product and/or a commercially available product may be used. The commercially available product of (d-1) is not particularly limited. Examples of the commercially available product of (d-1) include N300, M612, M13, M27, and LM1 (manufactured by TOKUSEN KOGYO Co., Ltd.).

As (d-1), one type of plate-shaped silver particles may be used, or two or more types of plate-shaped silver particles may be used in combination.

The content of (d-1) is not particularly limited, but is preferably 10 to 500 parts by mass, more preferably 30 to 200 parts by mass, still more preferably 50 to 100 parts by mass, and particularly preferably 60 to 90 parts by mass, with respect to 100 parts by mass of the component (A). The content of (d-1) is 10 parts by mass or more with respect to 100 parts by mass of the component (A), thereby allowing to obtain an electroconductive resin composition having excellent conductivity of the cured product, such as a connection resistance value and volume resistivity. The content of (d-1) is 500 parts by mass or less with respect to 100 parts by mass of the component (A), thereby allowing to obtain an electroconductive resin composition having excellent workability. If two or more types of epoxy resins are used as the component (A), the content of the component (A) refers to the total amount thereof. If two or more types of plate-shaped silver particles are used as the (d-1), the content of (d-1) refers to the total amount thereof.

((d-2): Electroconductive Particles Other than Plate-shaped Silver Particles)

The electroconductive particles other than the plate-shaped silver particles of (d-2) (hereinafter also simply referred to as “electroconductive particles of (d-2)”) are electroconductive particles not included in (d-1). The electroconductive particles of (d-2) are not particularly limited in terms of the material or shape of the particles, as long as they exhibit conductivity.

(d-2) can be appropriately selected from, for example, metal particles composed of one type selected from the group consisting of gold, silver, copper, nickel, palladium, platinum, tin, bismuth, and the like; alloy particles made of a combination of a plurality of types selected from the group consisting of these metals; particles with the surface-coated with these metals (at least one type selected from the group consisting of these metals) as a coating layer; and the like. These may be used singly, or two or more types may be used in combination. From the viewpoints such as conductivity and cost, (d-2) preferably contains metal particles, more preferably contains metal particles containing at least one type selected from the group consisting of gold, silver, copper, nickel, palladium, platinum, tin, and bismuth, and still more preferably contains silver particles. As one example, from the viewpoints such as conductivity and cost, (d-2) is preferably metal particles, more preferably is metal particles containing at least one type selected from the group consisting of gold, silver, copper, nickel, palladium, platinum, tin, and bismuth, and still more preferably is silver particles.

The shape of (d-2) is not particularly limited. Examples of the shape of (d-2) include spherical, amorphous, flake-shaped (scale-like), filament-like (needle-like), and dendrite-like shape. Particles of these shapes may be used singly or in combination. In the present description, flake-shaped particles refer to flaky particles other than plate-shaped particles (flaky particles excluding plate-shaped particles). (d-2) preferably contains flake-shaped particles, more preferably contains flake-shaped silver particles, and still more preferably is flake-shaped silver particles. However, if (d-2) contains silver particles, the silver particles are not plate-shaped silver particles. In addition, regardless of whether (d-2) is silver particles or not, (d-2) is preferably electroconductive particles having a shape other than plate-shaped particles.

As described above, the shape and surface condition of the particles can be confirmed by common techniques such as a scanning electron microscope (SEM). Whether (d-2) is plate-shaped (plate-like) flaky particles with a uniform thickness can be determined by observing the particles with a scanning electron microscope (SEM), similar to the determination of the shape of (d-1) described above. Whether (d-2) has a smooth surface can be determined by observing the particles with an SEM image, similar to the determination of the surface condition of (d-1) described above.

The thickness variation of (d-2) is not particularly limited. If (d-2) contains flake-shaped silver particles, the thickness variation of the flake-shaped silver particles is preferably more than ±10% of the thickness of the powder (the flake-shaped silver particles). In another embodiment, it is preferable that (d-2) is flake-shaped silver particles, and the thickness variation of the flake-shaped silver particles is more than ±10% with respect to the thickness of the powder (the flake-shaped silver particles). In yet another embodiment, the thickness variation of (d-2) includes more than ±10% with respect to the thickness of the powder (electroconductive particles other than plate-shaped silver particles), and the like. The thickness variation of (d-2) is determined by measuring the thickness at three points per one particle (one particle) of a powder (electroconductive particles other than plate-shaped silver particles) using a scanning electron microscope (SEM) and calculating the average value.

In one embodiment, preferable examples include a case where the variation in thickness of (d-1) is within a range of ±10% (preferably within a range of ±58, or the like) with respect to the thickness of the powder (plate-shaped silver particles), and the variation in thickness of the flake-shaped silver particles is preferably more than ±10% with respect to the thickness of the powder (the flake-shaped silver particles) when (d-2) contains flake-shaped silver particles.

In another embodiment, preferable examples include a case where the thickness variation of (d-1) is within a range of ±10% (preferably within a range of ±5%, or the like) with respect to the thickness of the powder (plate-shaped silver particles), (d-2) is flake-shaped silver particles, and the thickness variation of the flake-shaped silver particles is more than ±10% with respect to the thickness of the powder (the flake-shaped silver particles).

In yet another embodiment, preferable examples include a case where a variation in thickness of (d-1) is within a range of ±10% (preferably within a range of ±58, or the like) with respect to the thickness of the powder (plate-shaped silver particles), and the thickness variation of (d-2) is more than ±10% with respect to the thickness of the powder (electroconductive particles other than plate-shaped silver particles).

The arithmetic average roughness Ra of the surface of (d-2) is not particularly limited. In one embodiment, when (d-2) contains flake-shaped silver particles, the arithmetic average roughness of the surface of the flake-shaped silver particles is preferably more than 10.0 nm. When (d-2) contains flake-shaped silver particles, the arithmetic average roughness of the surface of the flake-shaped silver particles is preferably 20 μm or less. In another embodiment, (d-2) is more preferably flake-shaped silver particles having an arithmetic average roughness of the surface of more than 10.0 nm. (d-2) is preferably flake-shaped silver particles having an arithmetic average roughness of the surface of 20 μm or less. In yet another embodiment, the arithmetic average roughness of the surface of (d-2) is more preferably more than 10.0 nm. The arithmetic average roughness of the surface of (d-2) is preferably 20 μm or less. The arithmetic average roughness Ra of the surface of (d-2) can be evaluated in the same manner as the arithmetic average roughness of the surface of (d-1).

In one embodiment, preferable examples include a case where the arithmetic average roughness Ra of the surface of (d-1) of 10.0 nm or less (preferably, 8.0 nm or less, 3.5 nm or less, 1.0 nm or more and 10.0 nm or less, 1.0 nm or more and 8.0 nm or less, 1.0 nm or more and 3.5 nm or less, or the like), and the arithmetic average roughness Ra of the surface of the flake-shaped silver particles of more than 10.0 nm (preferably, more than 10.0 nm and 20 μm or less, or the like) when (d-2) contains flake-shaped silver particles.

In another embodiment, preferable examples include a case where the arithmetic average roughness Ra of the surface of (d-1) of 10.0 nm or less (preferably, 8.0 nm or less, 3.5 nm or less, 1.0 nm or more and 10.0 nm or less, 1.0 nm or more and 8.0 nm or less, 1.0 nm or more and 3.5 nm or less, or the like), and (d-2) is flake-shaped silver particles having a surface arithmetic average roughness Ra of more than 10.0 nm (preferably, more than 10.0 nm and 20 μm or less, or the like).

In yet another embodiment, preferable examples include a case where the arithmetic average roughness Ra of the surface of (d-1) of 10.0 nm or less (preferably, 8.0 nm or less, 3.5 nm or less, 1.0 nm or more and 10.0 nm or less, 1.0 nm or more and 8.0 nm or less, 1.0 nm or more and 3.5 nm or less, or the like), and the arithmetic average roughness Ra of the surface of (d-2) of more than 10.0 nm (preferably, more than 10.0 nm and 20 μm or less, or the like).

(d-2) may be surface-treated with a lubricant. (d-2) preferably contains electroconductive particles surface-treated with a lubricant, and more preferably is electroconductive particles surface-treated with a lubricant. The lubricant is not particularly limited. For example, a saturated fatty acid and/or an unsaturated fatty acid can be used as the lubricant. For example, the lubricant contains at least one type selected from the group consisting of a saturated fatty acid and an unsaturated fatty acid, and is preferably at least one type selected from the group consisting of a saturated fatty acid and an unsaturated fatty acid. Examples of the lubricant includes capric acid, undecylic acid, lauric acid, tridecylic acid, myristic acid, pentadecylic acid, palmitic acid, margaric acid, stearic acid, linolenic acid, linoleic acid, palmitoleic acid, and oleic acid, and stearic acid is preferable from the viewpoint of excellent dispersibility and storage stability. These may be used singly, or may be used in a combination of two or more types. The lubricant preferably contains at least one type selected from the group consisting of the compounds listed above, and more preferably contains stearic acid. As one example, the lubricant is preferably at least one type selected from the group consisting of the compounds listed above, and more preferably is stearic acid.

For example, in the electroconductive resin composition, one preferable example includes that (d-1) and (d-2) are silver powders (silver particles) surface-treated with stearic acid.

The average particle size of (d-2) is not particularly limited, but is preferably 0.1 to 30 μm, more preferably 0.5 to 20 μm, still more preferably 1 to 10 μm, and particularly preferably 1.0 μm or more and less than 4.0 μm. If the average particle size of (d-2) is 0.1 μm or more, the increase in viscosity can be further suppressed, and the workability is more excellent. If the average particle size of (d-2) is 30 μm or less, an electroconductive resin composition having better conductivity of the cured product can be obtained. Herein, the average particle size of (d-2) is the particle size (D50) at a cumulative volume ratio of 50% in the particle size distribution obtained by a laser diffraction scattering method. As one example, the average particle size of (d-2) can be measured by a laser diffraction scattering type shape distribution measuring instrument.

For example, in the electroconductive resin composition, one preferable example includes the average particle size of each of (d-1) and (d-2) is 0.1 to 30 μm.

The specific surface area of (d-2) is not particularly limited. In one embodiment, the specific surface area of (d-2) is preferably 0.01 to 10 m²/g, more preferably 0.1 to 5.0 m²/g, still more preferably 0.2 to 3.0 m²/g, and particularly preferably 0.20 m²/g or more and less than 0.50 m²/g. If the specific surface area of (d-2) is 0.01 m²/g or more, an electroconductive resin composition having excellent conductivity of the cured product can be obtained. If the specific surface area of (d-2) is 10 m²/g or less, an electroconductive resin composition having excellent workability can be obtained. In another embodiment, the specific surface area of (d-2) is preferably 0.01 m²/g or more and less than 0.50 m²/g, more preferably 0.10 m²/g or more and less than 0.50 m²/g, and still more preferably 0.20 m²/g or more and less than 0.50 m²/g. The specific surface area herein is a value calculated by the BET method.

In one embodiment, preferable examples include a case where a specific surface area of (d-1) is 0.50 m²/g or more (for example, 0.50 m²/g or more, 0.50 to 7.00 m²/g, 0.50 to 5.00 m²/g, 0.50 to 3.00 m²/g, 0.90 to 3.00 m²/g, 1.00 to 3.00 m²/g, or the like), a specific surface area of (d-2) is 0.01 m²/g or more and less than 0.50 m²/g (for example, 0.10 m²/g or more and less than 0.50 m²/g, 0.20 m²/g or more and less than 0.50 m²/g, or the like) if (d-2) is flake-shaped silver particles, and 0.01 to 10.00 m²/g (for example, 0.01 to 10.00 m²/g, 0.10 to 5.00 m²/g, 0.20 to 3.00 m²/g, or the like) if (d-2) is particles other than flake-shaped silver particles.

In another embodiment, preferable examples include a case where a specific surface area of (d-1) is 0.50 m²/g or more (for example, 0.50 m²/g or more, 0.50 to 7.00 m²/g, 0.50 to 5.00 m²/g, 0.50 to 3.00 m²/g, 0.90 to 3.00 m²/g, 1.00 to 3.00 m²/g, or the like), (d-2) is flake-shaped silver particles, and a specific surface area of (d-2) is 0.01 m²/g or more and less than 0.50 m²/g (for example, 0.10 m²/g or more and less than 0.50 m²/g, 0.20 m²/g or more and less than 0.50 m²/g, or the like).

In yet another embodiment, preferable examples include a case where a specific surface area of (d-1) is 0.50 m²/g or more (for example, 0.50 m²/g or more, 0.50 to 7.00 m²/g, 0.50 to 5.00 m²/g, 0.50 to 3.00 m²/g, 0.90 to 3.00 m²/g, 1.00 to 3.00 m²/g, or the like), and a specific surface area of (d-2) is 0.01 m²/g or more and less than 0.50 m²/g (for example, 0.10 m²/g or more and less than 0.50 m²/g, 0.20 m²/g or more and less than 0.50 m²/g, or the like).

As (d-2), a synthetic product and/or a commercially available product may be used. The commercially available product of (d-2) is not particularly limited. Examples of the commercially available product of (d-2) include Sylvest (registered trademark) TC-770 (manufactured by TOKURIKI HONTEN CO., LTD.).

As the component (d-2), one type of electroconductive particles may be used, or two or more types of electroconductive particles may be used in combination.

The content of (d-2) is not particularly limited, but is preferably 50 to 500 parts by mass, more preferably 100 to 300 parts by mass, and still more preferably 200 to 250 parts by mass, with respect to 100 parts by mass of the component (A). The content of (d-2) is 50 parts by mass or more with respect to 100 parts by mass of the component (A), thereby allowing to obtain an electroconductive resin composition having excellent conductivity such as connection resistance value and volume resistivity of the cured product. The content of (d-2) is 500 parts by mass or less with respect to 100 parts by mass of the component (A), thereby allowing to obtain an electroconductive resin composition having excellent workability. If two or more types of epoxy resins are used as the component (A), the content of the component (A) refers to the total amount thereof. If two or more types of electroconductive particles are used as (d-2), the content of (d-2) refers to the total amount thereof.

The mass ratio between (d-1) and (d-2) is not particularly limited, but is preferably (d-1): (d-2)=10:0 to 90:10, more preferably (d-1): (d-2)=10:90 to 75:25, still more preferably (d-1): (d-2)=15:85 to 50:50, and particularly preferably (d-1):(d-2)=20:80 to 40:60. The mass ratio between (d-1) and (d-2) is in the range of (d-1):(d-2)=10:90 to 90:10, thereby allowing to obtain an electroconductive resin composition having excellent conductivity of the cured product, such as a connection resistance value and volume resistivity. If two or more types of plate-shaped silver particles are used as (d-1), the content of (d-1) is intended to be the total amount thereof. If two or more types of electroconductive particles are used as (d-2), the content of (d-2) is intended to be the total amount thereof.

### (Content of Component (D))

The content of the component (D) is not particularly limited, but is preferably 100 to 500 parts by mass, more preferably 200 to 400 parts by mass, and still more preferably 250 to 350 parts by mass, with respect to 100 parts by mass of the component (A). The content of the component (D) is 100 parts by mass or more with respect to 100 parts by mass of the component (A), thereby allowing to obtain an electroconductive resin composition with excellent conductivity of the cured product. The content of the component (D) is 500 parts by mass or less with respect to 100 parts by mass of the component (A), thereby allowing to obtain an electroconductive resin composition with excellent workability. If two or more types of epoxy resins are used as the component (A), the content of the component (A) is intended to be the total amount of the epoxy resins. In addition, the component (D) includes (d-1) and (d-2). If two or more types of plate-shaped silver particles are used as (d-1), the content of (d-1) is intended to be the total amount thereof. If two or more types of electroconductive particles are used as (d-2), the content of (d-2) is intended to be the total amount thereof.

The content of the component (D) is not particularly limited, but is preferably 40 to 90% by mass, more preferably 50 to 80% by mass, and still more preferably 55 to 75% by mass with respect to the entire electroconductive resin composition (total mass of the electroconductive resin composition). The content of the component (D) is 40% by mass or more with respect to the entire electroconductive resin composition (total mass of the electroconductive resin composition), thereby allowing to obtain an electroconductive resin composition having excellent conductivity such as a connection resistance value and volume resistivity of the cured product. The content of the component (D) is 90% by mass or less with respect to the entire electroconductive resin composition (total mass of the electroconductive resin composition), thereby allowing to obtain an electroconductive resin composition having excellent workability. The component (D) includes (d-1) and (d-2). If two or more types of plate-shaped silver particles are used as (d-1), the content of (d-1) is intended to be the total amount thereof. If two or more types of electroconductive particles are used as (d-2), the content of (d-2) is intended to be the total amount thereof.

### [Component (E)]

The component (E) is an epoxy curing agent. The component (E) is not particularly limited as long as it cures epoxy resin. Examples of a compound used as the component (E) include an amine compound, an imidazole compound, an adduct-type latent curing agent (a reaction product of an amine compound with an epoxy compound, an isocyanate compound, or a urea compound), dicyandiamide, a hydrazide compound, a boron trifluoride-amine complex, a thiol compound, and an acid anhydride. As the component (E), a latent curing agent is preferable. Examples of a compound used as the latent curing agent include an imidazole compound, an adduct-type latent curing agent, dicyandiamide, a hydrazide compound, a boron trifluoride-amine complex, and an acid anhydride. These may be used singly, or two or more types may be used in combination. The component (E) preferably contains at least one type selected from the group consisting of the compounds listed above, and more preferably is at least one type selected from the group consisting of the compounds listed above. As one example, from the viewpoint of the balance between storage stability and curing ability, the component (E) preferably contains a latent curing agent, and more preferably contains an adduct-type latent curing agent. As another example, from the viewpoint of the balance between storage stability and curability, the component (E) is preferably a latent curing agent, and more preferably an adduct-type latent curing agent.

The adduct-type latent curing agent is not particularly limited. Examples of the adduct-type latent curing agent include a reaction product of an amine compound and an isocyanate compound or a urea compound (urea-adduct-type latent curing agent), and a reaction product of an amine compound and an epoxy compound (epoxyamine-adduct-type latent curing agent). The adduct-type latent curing agent may be used singly or two or more types may be used in combination. The urea-adduct-type latent curing agent and the epoxyamine-adduct-type latent curing agent may each be used singly or two or more types may be used in combination. The adduct-type latent curing agent preferably contains at least one type selected from the group consisting of a urea-adduct-type latent curing agent and an epoxyamine-adduct-type latent curing agent, more preferably contains a urea-adduct-type latent curing agent, and still more preferably contains a modified aliphatic polyamine-based latent curing agent. As one example, from the viewpoint of the balance between storage stability and curability, the adduct-type latent curing agent is preferably at least one type selected from the group consisting of a urea-adduct-type latent curing agent and an epoxy amine-adduct-type latent curing agents, preferably a urea-adduct-type latent curing agent, and still more preferably a modified aliphatic polyamine-based latent curing agent.

The compound used as the component (E) may be either liquid or solid, but from the viewpoint of storage stability, a solid is preferable, and a powder is still more preferable. In the present description, “solid” means a state that has substantially no fluidity at 25° C. Specifically, “state that has substantially no fluidity at 25° C.” refers to a state in which the viscosity measured at 25° C. using a cone-plate rotational viscometer at a shear rate of 10 s⁻¹ is more than 1,000 Pa·s, or the fluidity is extremely low or nonexistent and the viscosity cannot be measured at 25° C. using a cone-plate rotational viscometer at a shear rate of 10 s⁻¹.

If the component (E) is a powder, the average particle size of the powder is not particularly limited, but is preferably 0.1 to 30 μm, more preferably 0.5 to 20 μm, and still more preferably 1 to 10 μm. If the average particle size of the powder is 0.1 μm or more, the viscosity of the electroconductive resin composition is less likely to increase. If the average particle size of the powder is 30 μm or less, the contact area between the component (E) and the component (A) increases, resulting in better curability. Herein, the average particle size of the component (E) is the particle size (D50) at a cumulative volume ratio of 50% in the particle size distribution determined by a laser diffraction scattering method. As one example, the average particle size of (d-1) can be measured by a laser diffraction scattering type shape distribution measuring instrument.

As the component (E), a synthetic product and/or a commercially available product may be used. There is no particular limitation on the commercially available product of the component (E). Examples of the urea-adduct-type latent curing agent include Fujicure (registered trademark) FXE-1000, FXR-1020, FXR-1030, FXB-1050, and FXR-1081 (manufactured by T&K TOKA CO., LTD.). Examples of the epoxy amine-adduct-type latent curing agent include Amicure PN-23, Amicure PN-H, Amicure PN-31, Amicure PN-40, Amicure PN-50, Amicure PN-F, Amicure PN-23J, Amicure PN-31J, Amicure PN-40J, Amicure MY-24, Amicure MY-25, Amicure MY-R, and Amicure PN-R (manufactured by Ajinomoto Fine-Techno Co., Inc.). These may be used singly, or two or more types may be used in combination.

As the component (E), one type of an epoxy curing agent may be used, or two or more types of epoxy curing agents may be used in combination.

The content of the component (E) is not particularly limited, but is preferably 1 to 100 parts by mass, more preferably 10 to 50 parts by mass, and still more preferably 15 to 40 parts by mass, with respect to 100 parts by mass of the component (A). The content of the component (E) is 1 part by mass or more with respect to 100 parts by mass of the component (A), thereby allowing to obtain an electroconductive resin composition having an excellent low temperature curing property of the cured product. The content of the component (E) is 100 parts by mass or less with respect to 100 parts by mass of the component (A), thereby allowing to obtain an electroconductive resin composition having excellent storage stability. If two or more types of epoxy resins are used as the component (A), the content of the component (A) is intended to be the total amount thereof. If two or more types of epoxy curing agents are used as the component (E), the content of the component (E) is intended to be the total amount thereof.

### [Organic Solvent]

The electroconductive resin composition according to the present aspect preferably does not contain an organic solvent. The organic solvent is liquid at 25° C. As described above, “liquid at 25° C.” means that the viscosity measured at 25° C. using a cone-plate rotational viscometer at a shear rate of 10 s⁻¹ is 1,000 Pa·s or less. If the electroconductive resin composition contains a solvent, the organic solvent dissolves the component (E), which deteriorates the storage stability or causes separation of the organic solvent, and thus the physical properties are affected. In the present description, “the electroconductive resin composition does not contain an organic solvent” means that the electroconductive resin composition does not intentionally contain an organic solvent as a formulation, and specifically means that the content of the organic solvent is 18 by mass or less with respect to the entire electroconductive resin composition (total mass of the electroconductive resin composition). Thus, in the electroconductive resin composition according to the present aspect, the content of the organic solvent is 0% by mass, or more than 0% by mass and 1% by mass or less, relative to the entire electroconductive resin composition (total mass of the electroconductive resin composition). The content of the organic solvent is preferably 0.5% by mass or less, more preferably 0.1% by mass or less, and still more preferably 0.01% by mass or less (lower limit: 0% by mass), with respect to the entire electroconductive resin composition (total mass of the electroconductive resin composition). It is particularly preferable that the electroconductive resin composition does not contain any organic solvent, that is, the content of the organic solvent is 0% by mass with respect to the entire electroconductive resin composition (total mass of the electroconductive resin composition). If the content of the organic solvent is 1% by mass or less with respect to the entire electroconductive resin composition (total mass of the electroconductive resin composition), deterioration of storage stability and separation do not occur.

The organic solvent is not particularly limited. Examples of the organic solvent include aromatic-based organic solvents such as toluene and xylene; aliphatic-based organic solvents such as n-hexane; alicyclic-based organic solvents such as cyclohexane, methylcyclohexane, and ethylcyclohexane; ketone-based organic solvents such as acetone and methyl ethyl ketone; alcohol-based organic solvents such as methanol and ethanol; ester-based organic solvents such as ethyl acetate and butyl acetate; and propylene glycol ether-based organic solvents such as propylene glycol methyl ether, propylene glycol ethyl ether, and propylene glycol t-butyl ether. The organic solvent may be used singly or two or more types may be used in combination. As one example, the organic solvent may contain at least one type of the organic solvent selected from the group consisting of an aromatic-based organic solvent, an aliphatic-based organic solvent, an alicyclic-based organic solvent, a ketone-based organic solvent, an alcohol-based organic solvent, an ester-based organic solvent, and a propylene glycol ether-based organic solvent, and may be at least one type of the organic solvent selected from the group consisting of an aromatic-based organic solvent, an aliphatic-based organic solvent, an alicyclic-based organic solvent, a ketone-based organic solvent, an alcohol-based organic solvent, a ester-based organic solvent, and a propylene glycol ether-based organic solvent.

### [Optional Component]

In addition to the above-described components (components (A) to (E)), each kind of additive can be added as an optional component (as necessary) to the electroconductive resin composition according to one embodiment, within the scope of not impairing the effects of the present invention. Examples of the additive include a silane coupling agent, a plasticizer, a filler (excluding components (C) and (D)), a storage stabilizer, a tackifier, an organic or inorganic pigment, a rust inhibitor, a defoamer, a dispersant, a surfactant, a viscoelasticity modifier, a thickener, an organometallic complex, and a resin, but the additive is not limited to these. Among these, the optional component preferably includes at least one type selected from the group consisting of a silane coupling agent, a storage stabilizer, an organometallic complex, and a resin, and more preferably includes a storage stabilizer.

### [Silane Coupling Agent]

The electroconductive resin composition according to one embodiment may contain a silane coupling agent. Examples of the silane coupling agent include glycidyl group-containing silane coupling agents such as 3-glycidoxypropyltriethoxysilane, 3-glycidoxypropylmethyldimethoxysilane, 3-glycidoxypropyltrimethoxysilane, and 3-glycidoxypropylmethyldiethoxysilane; vinyl group-containing silane coupling agents such as vinyltris(β-methoxyethoxy)silane, vinyltriethoxysilane, and vinyltrimethoxysilane; (meth)acrylic group-containing silane coupling agents such as γ-methacryloxypropyltrimethoxysilane; amino group-containing silane coupling agents such as N-β-(aminoethyl)-γ-aminopropyltrimethoxysilane, γ-aminopropyltriethoxysilane, and N-phenyl-γ-aminopropyltrimethoxysilane; γ-mercaptopropyltrimethoxysilane, γ-chloropropyltrimethoxysilane, and oligomers thereof, and a glycidyl group-containing silane coupling agent is preferable because of excellent adhesion. In the present description, a compound having one or more epoxy groups and a silicon atom in one molecule, such as a glycidyl group-containing silane coupling agent, is not treated as the above component (A) and the above component (B). That is, the compound having one or more epoxy groups and a silicon atom in one molecule, such as a glycidyl group-containing silane coupling agent, is not included in the above component (A) and the above component (B). In the present description, a glycidyl group-containing silane coupling agent is treated as a silane coupling agent (that is, one of the optional components). These may be used singly, or two or more types may be used in combination.

As the silane coupling agent, a commercially available product and/or a synthetic product may be used. The commercially available silane coupling agent is not particularly limited. Examples of the commercially available silane coupling agent include KBM-1003, KBE-1003, KBM-303, KBM-403, KBE-403, KBM-502, KBE-502, KBM-503, KBE-503, KBM-5103, KBM-1403, KBM-602, KBM-603, KBM-903, KBE-903 (manufactured by Shin-Etsu Chemical Co., Ltd.),

Z-6610, Z-6044, Z-6825, Z-6033, and Z-6062 (manufactured by DuPont Toray Specialty Materials K.K.).

The silane coupling agent may be used singly or two or more types may be used in combination.

### [Storage Stabilizer]

The electroconductive resin composition according to one embodiment may contain a storage stabilizer. The storage stabilizer is not particularly limited as long as it improves the storage stability of the electroconductive resin composition. As the storage stabilizer, for example, a borate ester compound, phosphoric acid, an alkyl phosphate ester, p-toluenesulfonic acid, methyl p-toluenesulfonate, or the like may be blended. Examples of the borate ester compound include trimethyl borate, triethyl borate, tri-n-propyl borate, triisopropyl borate, tributyl borate, trihexyl borate, tri-n-octyl borate, tris(2-ethylhexyloxy) borane, triphenylborate, trimethoxyboroxine, and 2,2′-(carbonylbisoxy)bis(1,3,2-dioxaborolane-4,5-dione. As the storage stabilizer, a commercially available product and/or a synthetic product may be used. Examples of the commercially available borate ester compound include “Cureduct (registered trademark) L-07N” (manufactured by SHIKOKU CHEMICALS CORPORATION). Examples of the alkyl phosphate ester that can be used include trimethyl phosphate and tributyl phosphate, but the alkyl phosphate ester is not limited to these. The storage stabilizer may be used singly or in combination of several. The storage stabilizer preferably contains at least one type selected from the group consisting of a borate ester compound, phosphoric acid, an alkyl phosphate ester, p-toluenesulfonic acid, and methyl p-toluenesulfonate. The borate ester compound preferably contains at least one type selected from the group consisting of the compounds listed above as specific examples of the borate ester compound, and more preferably is at least one type selected from the group consisting of the compounds listed above as specific examples of the borate ester compound. As one example, in consideration of storage stability, the storage stabilizer preferably contains at least one type selected from the group consisting of phosphoric acid, a borate ester compound (as one example, tributyl borate, trimethoxyboroxine, 2,2′-(carbonylbisoxy)bis(1,3,2-dioxaborolane-4,5-dione), and methyl p-toluenesulfonate, and more preferably contains a borate ester As another example, in consideration of storage compound. stability, the storage stabilizer preferably is at least one type selected from the group consisting of phosphoric acid, a borate (as ester compound one example, tributyl borate, trimethoxyboroxine, 2,2′-(carbonylbisoxy)bis(1,3,2-dioxaborolane-4,5-dione), and methyl p-toluenesulfonate, and more preferably is a borate ester compound. As yet another example, in consideration of storage stability, the storage stabilizer preferably contains 2,2′-(carbonylbisoxy)bis(1,3,2-dioxaborolane-4,5-dione, and more preferably is 2,2′-(carbonylbisoxy)bis(1,3,2-dioxaborolane-4,5-dione. The storage stabilizer dispersed in an epoxy resin or a phenolic resin may be used. When adding the storage stabilizer, if a mixture containing the storage stabilizer and an epoxy resin is added, the epoxy resin is preferably the component (A).

The storage stabilizer may be used singly or two or more types may be used in combination.

The content of the storage stabilizer is preferably 0.01 to 20 parts by mass, more preferably 0.05 to 10 parts by mass, and still more preferably 0.1 to 5 parts by mass, with respect to 100 parts by mass of the component (A). The content of the storage stabilizer is 0.01 part by mass or more, thereby allowing to fully obtain the effect of the storage stabilizer, and is 20 parts by mass or less, thereby allowing to obtain an electroconductive resin composition having excellent workability. If two or more types of epoxy resins are used as the component (A), the content of the component (A) is intended to be the total amount thereof. If two or more types of storage stabilizers are used, the content of the storage stabilizer is intended to be the total amount thereof.

### [Organometallic Complex]

The electroconductive resin composition according to one embodiment may contain an organometallic complex. The addition of an organometallic complex reduces the connection resistance to an adherend with an outermost surface being nickel, although the reason is unclear. Examples of the metal contained in the organometallic complex include divalent or trivalent metal, and more specific examples include zinc, aluminum, iron, cobalt, nickel, tin, and copper. Although the exact reason is unclear, by adding an organometallic complex containing the above-described divalent or trivalent metal, an electroconductive adhesive having lower connection resistance of the cured product, even in the case of the adherend with an outermost surface being nickel and having more excellent storage stability and more excellent handling can be obtained. In addition, the organometallic complex is not particularly limited, but preferably contains an organometallic complex containing an organic ligand having an alkoxy group and/or a carboxylate group, and more preferably is an organometallic complex containing an organic ligand having an alkoxy group and/or a carboxylate group. Examples of the organic ligand include acetate, acetylacetate, hexanoate, and phthalocyanate, but the organic ligand is not limited to these. Although the exact reason is unclear, by adding an organometallic complex containing the above organic ligand, an electroconductive resin composition having a lower connection resistance value of the cured product, even in the case of the adherend with an outermost surface being nickel, and having more excellent storage stability and more excellent handling can be obtained.

Examples of the organometallic complex include copper oleate (divalent), zinc acetylacetate (zinc acetylacetonate) (divalent), aluminum acetylacetate (aluminum acetylacetonate) (trivalent), cobalt acetylacetate (cobalt acetylacetonate) (divalent), nickel acetate (divalent), nickel acetylacetate (nickel acetylacetonate) (divalent), iron phthalocyanine (divalent), and dibutyltin dilaurate (divalent), but the organometallic complex is not limited to these.

As the organometallic complex, a commercially available product and/or a synthetic product may be used. Examples of the organometallic complex commercially available include, but are not limited to, Nacem Zinc (zinc acetylacetonate (divalent)), Nacem Aluminum (aluminum acetylacetonate (trivalent)), Nacem Dicobalt (cobalt acetylacetonate (divalent)), and Nacem Nickel (nickel acetylacetonate (divalent)) manufactured by NIHON KAGAKU SANGYO co., LTD.; and KS-1260 (dibutyltin dilaurate (divalent)) manufactured by KYODO CHEMICAL COMPANY LIMITED.

The organometallic complex may be used singly or two or more types may be used in combination.

The organometallic complex is preferably contained in an amount of 0.01 to 20 parts by mass, more preferably 0.1 to 15 parts by mass, and still more preferably 0.5 to 10 parts by mass, with respect to 100 parts by mass of the component (E). The organometallic complex is contained in an amount of 0.01 part by mass or more with respect to 100 parts by mass of the component (E), thereby further reducing the connection resistance value of the cured product, and the organometallic complex is contained in an amount of 20 parts by mass or less with respect to 100 parts by mass of the component (E), thereby allowing to maintain storage stability. If two or more types of epoxy curing agents are used as the component (E), the content of the component (E) is intended to be the total amount thereof. If two or more types of organometallic complexes are used, the content of the organometallic complex is intended to be the total amount thereof.

The organometallic complex is preferably contained in an amount of 0.01 to 10 parts by mass, more preferably 0.05 to 7 parts by mass, and still more preferably 0.1 to 5 parts by mass, with respect to 100 parts by mass of the component (A). The organometallic complex is contained in an amount of 0.01 part by mass or more with respect to 100 parts by mass of the component (A), thereby further reducing the connection resistance value of the cured product, and the organometallic complex is contained in an amount of 10 parts by mass or less with respect to 100 parts by mass of the component (A), thereby allowing to maintain storage stability. If two or more types of epoxy resins are used as the component (A), the content of the component (A) is intended to be the total amount thereof. If two or more types of organometallic complexes are used, the content of the organometallic complex is intended to be the total amount thereof.

### [Resin]

The electroconductive resin composition according to one embodiment may contain a resin (excluding the components (A) and (B)) as an optional component. Examples of the resin as the optional component include thermosetting resins such as a phenolic resin (preferably novolak phenolic resins such as a phenol novolac resin and a cresol novolak resin), a urea (urea) resin, a melamine resin, a (meth)acrylic resin, a vinyl ester resin, an unsaturated polyester resin, a bismaleimide resin, and a polyurethane resin; and thermoplastic resins such as a polyethylene resin, a polypropylene resin, an ethylene-propylene copolymer, an ethylene-vinyl acetate copolymer, a polyvinyl chloride resin, a polystyrene resin, a polyacrylonitrile resin, a polyamide resin, a polycarbonate resin, and a thermoplastic urethane resin but the resin is not limited to these. In particular, as one example, from the viewpoint of obtaining an electroconductive paste having excellent curability, the resin as an optional component preferably contains a thermosetting resin and/or a thermoplastic resin, more preferably contains a thermosetting resin, still more preferably contains a phenolic resin, and particularly preferably contains a novolak phenolic resin. As another example, from the viewpoint of obtaining an electroconductive paste having excellent curability, the resin as an optional component is preferably a thermosetting resin and/or a thermoplastic resin, more preferably a thermosetting resin, still more preferably a phenolic resin, and particularly preferably a novolak phenolic resin. Further, if the optional storage stabilizer is in a form dispersed in the phenolic resin, the phenolic resin contained therein (preferably a novolak phenolic resin) is considered to be included in the resin as an optional component.

The resin may be used singly or two or more types may be used in combination.

The content of the resin as an optional component is preferably 0.01 to 10 parts by mass, more preferably 0.03 to 5 parts by mass, and particularly preferably 0.05 to 1 part by mass, with respect to 100 parts by mass of the component (A). If two or more types of epoxy curing agents are used as the component (A), the content of the component (A) is intended to be the total amount thereof. If two or more types of resins are used as optional components, the content of the organometallic complex is intended to be the total amount thereof.

The electroconductive resin composition according to one embodiment is substantially composed of the above components (A) to (E) and at least one type selected from the group consisting of a silane coupling agent, a storage stabilizer, an organometallic complex, and a resin. The electroconductive resin composition according to one preferable embodiment is substantially composed of the above components (A) to (E) and a storage stabilizer. In the above embodiment, “the electroconductive resin composition is substantially composed of X” means that the total content of X is more than 99% by mass (upper limit: 100% by mass) in a case where the total mass of the electroconductive resin composition is 100% by mass (relative to the entire electroconductive resin composition). For example, “the electroconductive resin composition according to the present invention is substantially composed of the components (A) to (E) and at least one type selected from the group consisting of a silane coupling agent, a storage stabilizer, an organometallic complex, and a resin” means that the total content (total amount added) of the components (A) to (E), the silane coupling agent, the storage stabilizer, the organometallic complex, and the resin is more than 99% by mass (upper limit: 100% by mass) in a case where the total mass of the electroconductive resin composition is 100% by mass (with respect to the entire electroconductive resin composition). For example, “the electroconductive resin composition according to the present invention is substantially composed of the above components (A) to (E) and a storage stabilizer” means that the total content (total amount added) of the components (A) to (E) and a storage stabilizer is more than 99% by mass (upper limit: 100% by mass) in a case where the total mass of the electroconductive resin composition is 100% by mass (with respect to the entire electroconductive resin composition).

### Cured Product

The electroconductive resin composition according to the above aspect can be cured by heating, and can be cured even at low temperatures (less than 100° C.). Therefore, another aspect of the present invention relates to a cured product (cured product of the electroconductive resin composition) obtained by curing the electroconductive resin composition according to the above aspect.

The method for producing the cured product (the method for curing the electroconductive resin composition) is not particularly limited, and a known method can be used. One example includes a method in which the electroconductive resin composition according to the above aspect is applied to an adherend, and then heated to be cured. Therefore, in order to improve the workability during application, it is preferable that the electroconductive resin composition is liquid (liquid-like). As described above, “liquid at 25° C.” means that the viscosity measured at 25° C. using a cone-plate rotational viscometer at a shear rate of 10 s⁻¹ is 1,000 Pa·s or less. As one example, the viscosity of the electroconductive resin composition at 25° C. is preferably 0.01 Pa·s or more and less than 100 Pa·s, more preferably 0.1 to 50 Pa·s, still more preferably 0.5 to 50 Pa·s, particularly preferably 1 to 20 Pa·s, and still more particularly preferably 1 to 10 Pa·s. In the present description, the viscosity of the electroconductive resin composition is a viscosity measured at 25° C. using a cone-plate rotational viscometer at a shear rate of 10 s⁻¹.

When applying the electroconductive resin composition, the thickness of the applied film is not particularly limited, and is adjusted as appropriate within the range in which the adherend can be bonded. The heating conditions (curing conditions) are not particularly limited as long as the electroconductive resin composition can be sufficiently cured. Among the heating conditions in the method of curing the electroconductive resin composition, the heat curing temperature is not particularly limited, but, for example, from the viewpoint of reducing the thermal effect on the adherend, a temperature of 45 to 100° C. is preferable, and a temperature of 50 to 95° C. is more preferable. The heat curing time is not particularly limited, but in the case of a heat curing temperature of 45 to 100° C., from the viewpoint of reducing the thermal effect on the adherend, 10 minutes to 3 hours is preferable, and 30 minutes to 2 hours is more preferable.

### Adherend

The electroconductive resin composition according to one aspect of the present invention and the cured product according to another aspect of the present invention are preferably used for an adherend with an outermost surface being nickel. This is because the electroconductive resin composition having the above structure can have a low connection resistance value of the cured product, even in the case of the adherend with an outermost surface being nickel, have excellent storage stability, and exhibit excellent workability, although the exact reason is unclear. The adherend with an outermost surface being nickel is not particularly limited, and is mainly nickel-plated, and examples include a member made of SPCC (cold-rolled steel sheet), stainless steel, or copper, which has been electrolytically or electrolessly plated (electric wire, printed circuit board, and the like).

The embodiments of the present invention have been described in detail, and it is clear that the same are illustrative and exemplary, not restrictive, and the scope of the present invention should be interpreted by the appended claims.

The present invention encompasses the following aspects and embodiments, but is not limited thereto.

[1] An electroconductive resin composition containing the following components (A) to (E), wherein an organic solvent content is 1% by mass or less with respect to an entire electroconductive resin composition,
component (A): an epoxy resin having two or more epoxy groups in one molecule,
component (B): a reactive diluting agent having one epoxy group in one molecule,
component (C): rubber particles,
component (D): electroconductive particles containing the following (d-1) and (d-2),
(d-1): plate-shaped silver particles,
(d-2): electroconductive particles other than plate-shaped silver particles, and
component (E): an epoxy curing agent.
   [2] The electroconductive resin composition according to [1], wherein the component (C) contains core-shell particles.
   [3] The electroconductive resin composition according to [1] or [2], wherein an average particle size of the component (C) is 0.01 to 10 μm.
   [4] The electroconductive resin composition according to any one of [1] to [3], wherein an average particle size of each of the (d-1) and the (d-2) is 0.1 to 30 μm.
   [5] The electroconductive resin composition according to any one of [1] to [4], wherein the (d-1) and the (d-2) are silver powders surface-treated with stearic acid.
   [6] The electroconductive resin composition according to any one of [1] to [5], wherein the (d-1) contains single crystal plate-shaped silver particles.
   [7] The electroconductive resin composition according to any one of [1] to [6], wherein a mass ratio between the (d-1) and the (d-2) is (d-1):(d-2)=10:90 to 90:10.
   [8] The electroconductive resin composition according to any one of [1] to [7], wherein the component (E) contains an adduct-type latent curing agent.
   [9] The electroconductive resin composition according to any one of [1] to [8], which is used on an adherend with an outermost surface being nickel.
   [10] A cured product formed by curing the electroconductive resin composition according to any one of [1] to [9].

### EXAMPLE

The present invention will be described in more detail below with reference to examples, but the present invention is not limited to these examples. Unless otherwise specified, operations and tests were performed in an environment of 25° C. and 55% RH.

### Preparation of Electroconductive Resin Composition

### [Examples 1 and 2 and Comparative Examples 1 to 5]

The following components were made ready to prepare the electroconductive resin composition. Hereinafter, the electroconductive resin composition will be also simply referred to as the “composition”. The viscosity shown below is a value measured using a cone-plate rotational viscometer under an environment of 25° C. and 55% RH at a shear rate of 10 s⁻¹.

Component (A): an epoxy resin having two or more epoxy groups in one molecule.
EPICLON (registered trademark) EXA-835LV (a mixture of bisphenol A type epoxy resin and bisphenol F type epoxy resin, one molecule of bisphenol A type epoxy resin having two epoxy groups, one molecule of bisphenol F type epoxy resin having two epoxy groups, the mixing ratio (mass ratio) of bisphenol A type epoxy resin:bisphenol F type epoxy resin=50:50, epoxy equivalent: 165 g/eq, viscosity (25° C.) 2,000 mPa·s, manufactured by DIC Corporation)
Resin component of Kane Ace (registered trademark) MX-136 (rubber-dispersed epoxy resin (resin component: bisphenol F type epoxy resin, rubber particles: polybutadiene core-shell particles), one molecule of bisphenol F type epoxy resin having two epoxy groups, the mixing ratio (mass ratio) of resin component:rubber particles=75:25, epoxy equivalent: 226 g/eq, manufactured by KANEKA CORPORATION).
Bisphenol A type epoxy resin of Cureduct (registered trademark) L-07N (epoxy-phenol-borate ester formulation (containing 91% by mass of bisphenol A type epoxy resin (one molecule of bisphenol A type epoxy resin having two epoxy groups), 4% by mass of phenol novolak resin, and 5% by mass of borate ester compound (2,2′-(carbonylbisoxy)bis(1,3,2-dioxaborolane-4,5-dione)), manufactured by SHIKOKU CHEMICALS CORPORATION).

Component (B): a reactive diluting agent having one epoxy group in one molecule
CARDURA E10P (neodecanoic acid glycidyl ester, manufactured by Momentive Performance Materials Inc., epoxy equivalent: 240 g/eq, viscosity (25° C.) 7 mPa·s)

Component (B′): solvent
Acetone (reagent).

Component (C): rubber particles
Zefiac F-351G (polymethacrylic acid ester-based core-shell particles, average particle size (D50): 0.3 μm, manufactured by Aica Kogyo Co., Ltd.)
Rubber particles of Kane Ace (registered trademark) MX-136 (rubber-dispersed epoxy resin (resin component: bisphenol F type epoxy resin, rubber particles: polybutadiene-based core-shell particles), average particle size (D50) of rubber particles: 0.1 μm, mixing ratio (mass ratio) of resin component:rubber particles=75:25, manufactured by KANEKA CORPORATION).

Component (D): electroconductive particles containing (d-1) and (d-2)

(d-1): plate-shaped silver particles.
M27 (single crystal silver particles, plate-shaped, surface-treated with stearic acid, average particle size (D50): 4.5 μm, specific surface area: 1.0 m²/g, average thickness T: 80 nm, aspect ratio: 56.25, manufactured by TOKUSEN KOGYO Co., Ltd.)

(d-2): electroconductive particles other than plate-shaped silver particles
Silbest (registered trademark) TC-770 (flake-shaped silver particles, surface treated with stearic acid, average particle size (D50): 3.5 μm, specific surface area: 0.45 m²/g, manufactured by TOKURIKI HONTEN CO., LTD.).

Component (E): epoxy curing agent
Fujicure (registered trademark) FXR-1081 (modified aliphatic polyamine-based latent curing agent (urea adduct-type latent curing agent), average particle size (D50): 5 μm, manufactured by T&K TOKA CO., LTD.).

Optional component: storage stabilizer

Phenol novolak resin and borate ester compound (2,2′-(carbonylbisoxy)bis(1,3,2-dioxaborolane-4,5-dione) of Cureduct (registered trademark) L-07N (epoxy-phenol-borate ester formulation (containing 91% by mass of bisphenol A type epoxy resin (one molecule of bisphenol A type epoxy resin having two epoxy groups), 4% by mass of phenol novolak resin, and 5% by mass of borate ester compound (2,2′-(carbonylbisoxy)bis(1,3,2-dioxaborolane-4,5-dione)), manufactured by SHIKOKU CHEMICALS CORPORATION).

The above Silbest (registered trademark) TC-770 (manufactured by TOKURIKI HONTEN CO., LTD.) used as (d-2) has a flaky shape. However, for Silbest (registered trademark) TC-770 (manufactured by TOKURIKI HONTEN CO., LTD.), the thickness varies greatly within one particle, the upper and lower surfaces of the flakey shape are clearly not parallel, and significant unevenness and/or significant steps are observed on the particle surface. Therefore, Silbest (registered trademark) TC-770 (manufactured by TOKURIKI HONTEN CO., LTD.) is not plate-shaped silver particles, but flake-shaped silver particles.

The methods for producing the compositions according to Examples 1 and 2 and Comparative Examples 1 to 5 were as follows. The component (A), the component (B) (or the component (B)′), the component (C), the component (D) (the (d-1) and the (d-2)), and the optional components were weighed and mixed for 30 minutes using a planetary mixer. The component (E) was then weighed and added, and stirring was performed for an additional 30 minutes using the planetary mixer while degassing under vacuum to obtain an electroconductive resin composition.

For Example 1 and Comparative Examples 1 to 5, the compositions were produced such that the content of Cureduct (registered trademark) L-07N (manufactured by SHIKOKU CHEMICALS CORPORATION) was 2.5 parts by mass with respect to 100 parts by mass of EPICLON (registered trademark) EXA-835LV (manufactured by DIC Corporation).

In addition, for Example 2, the composition was produced such that the content of Cureduct (registered trademark) L-07N (manufactured by SHIKOKU CHEMICALS CORPORATION) was 2.5 parts by mass with respect to 100 parts by mass of the total of the mass of EPICLON (registered trademark) EXA-835LV (manufactured by DIC Corporation) and the mass of the resin component of KaneAce (registered trademark) MX-136 (manufactured by KANEKA CORPORATION).

All of the obtained electroconductive resin compositions were liquid at 25° C. Detailed preparation amounts (amount of each component added, content of each component) are in accordance with Table 1, and the unit of numerical values are parts by mass.

For example, the viscosity of the electroconductive resin composition of Example 1 as measured at 25° C. using a cone-plate rotational viscometer at a shear rate of 10 s⁻¹ was 9 Pa·s.

### Storage Stability Test

Using 2 mL of the electroconductive resin composition, the viscosity was measured under the following measurement conditions to determine the initial viscosity. Then, while leaving stand in a 25° C. atmosphere, measurement was performed every 12 hours until the viscosity increased by 20% over the initial viscosity, and the “storage stability” was determined according to the following evaluation criteria. In order not to change the amount of the composition discharged during discharging, it is preferable that the storage stability is “◯”. If the storage stability was “×”, the low temperature curing property test, the connection resistance value measurement, and the volume resistivity measurement were not performed.

### [Measurement Conditions]

Cone rotor: 3°×R2.4
Shear rate: 1.0 (1/s)
Measurement temperature: 25° C. (using temperature control device).

### [Evaluation Criteria]

◯: 48 hours or more at 25° C.
×: less than 48 hours at 25° C.

### Low Temperature Curing Property Test

A 50 μm thick masking tape was attached onto a glass plate having 100 mm length×50 mm width×2.0 mm thickness, such that the size was 100 mm length×10 mm width, and the composition was applied onto the glass plate with the masking tape attached using a squeegee to form a uniform film to prepare a test piece (n=2 per one condition). The test pieces were each placed in a hot air drying oven in an 80° C. atmosphere and left for 60 minutes, and then were removed from the hot air drying oven. After the temperature of the test pieces dropped to 25° C., the surface of the cured product (cured product of the electroconductive resin composition) was touched with a polytetrafluoroethylene stick to check whether any marks remained on the cured product. The symbol “-” means unmeasured.

### [Evaluation Criteria]

◯: no mark remains on cured product.
×: mark remains on cured product.

### Connection Resistance Value Measurement

Five holes, each 5 mm in diameter, were made at 10 mm intervals along the length direction in a masking tape having 10 mm width and 100 μm thickness. The masking tape was attached onto an electroless nickel-plated plate having 25 mm width×100 mm length×1.6 mm thickness, and the composition was applied using a squeegee onto the electroless nickel-plated plate with the masking tape attached. When applying the composition using a squeegee, care was taken to avoid introducing bubbles into the composition. The masking tape was then removed, and the composition was cured by heating at 80° C. for 60 minutes in a hot air drying oven. After the temperature of the test pieces dropped to room temperature, the needle electrodes of a dual display multimeter were brought into contact with adjacent cured products of the composition (two cured products positioned 10 mm apart) to measure the resistance, and the obtained resistance value was recorded as the “connection resistance value (Ω)”. To stabilize conductivity, the connection resistance value is preferably 0.15 Ω or less, and more preferably 0.10 Ω or less (lower limit: 0 Ω). Examples of a preferable range of connection resistance value include 0.001 Ω or more and 0.15 Ω or less, and examples of a more preferable range include 0.001 Ω or more and 0.10 Ω or less. If the connection resistance value is more than 10 Ω, volume resistance is not measured. The symbol “-” means unmeasured.

### Volume Resistivity Measurement

Masking was performed onto a glass plate having 100 mm length×100 mm width×2.0 mm thickness, such that the spacing between the masking tapes was 100 mm length×10 mm width×50 μm thickness, and the composition shown in Table 1 was applied onto the masked glass plate using a squeegee to form each film. In this case, the film surface was flat, and the width of the masking was parallel to the test plate. When applying the composition using a squeegee, care was taken to avoid introducing bubbles into the composition. The masking tape was then removed, and the composition was cured by heating at 80° C. for 60 minutes in a hot air drying oven to prepare a test piece. After the temperature of the test piece dropped to room temperature, the “resistance (Ω)” was measured in a case where the “electrode distance (m)” was 50 mm using a tester (microohmmeter manufactured by ADVANTEST CORPORATION) with 15 mm-width electrodes, and the “volume resistivity (Ω·m)” was calculated. From the viewpoint of conductivity, volume resistivity is preferably 10×10⁻⁵ Ω·m or less, and more preferably 5×10⁻⁵ Ω·m or less (lower limit: 0 Ω·m). Examples of a preferable range of volume resistivity include 0.1×10⁻⁵ Ω·m or more and 10×10⁻⁵ Ω·m or less, and examples of a more preferable range of volume resistivity include 0.1×10⁻⁵ Ω·m or more and 5×10⁻⁵ Ω·m or less.

The symbol “-” means unmeasured.

TABLE 1

| | | | Example | Example | Comparative | Comparative | Comparative | Comparative | Comparative |
|---|---|---|---|---|---|---|---|---|---|
| | | | 1 | 2 | Example 1 | Example 2 | Example 3 | Example 4 | Example 5 |
| Component (A) | | EXA-835LV | 100 | 85 | 100 | 100 | 100 | 100 | 100 |
| | | MX-136 resin | | 15 | | | | | |
| | | component | | | | | | | |
| | | L-07N Bisphenol A | 2.3 | 2.3 | 2.3 | 2.3 | 2.3 | 2.3 | 2.3 |
| | | type epoxy resin | | | | | | | |
| Component (B) | | E10P | 25 | 30 | | 25 | | 25 | 25 |
| Component (B′) | | Acetone | | | | | 25 | | |
| Component (C) | | F-351G | 0.1 | | 0.1 | | 0.1 | | |
| | | MX-136 rubber | | 5 | | | | | |
| | | particles | | | | | | | |
| Component | (d-1) | M27 | 80 | 80 | 80 | 80 | 80 | 300 | |
| (d) | (d-2) | TC-770 | 220 | 220 | 220 | 220 | 220 | | 300 |

| | | | | | | | | |
|---|---|---|---|---|---|---|---|---|
| Component (E) | FXR-1081 | 30 | 30 | 30 | 30 | 30 | 30 | 30 |
| Optional | L-07N Borate ester | 0.1 | 0.1 | 0.1 | 0.1 | 0.1 | 0.1 | 0.1 |
| component | compound | | | | | | | |
| | L-07N Phenol | 0.1 | 0.1 | 0.1 | 0.1 | 0.1 | 0.1 | 0.1 |
| | novolak resin | | | | | | | |

| | | | | | | | |
|---|---|---|---|---|---|---|---|
| Storage stability | ○ | ○ | ○ | ○ | x | ○ | ○ |
| Low temperature curing property | ○ | ○ | ○ | ○ | — | ○ | ○ |
| Connection resistance value [Ω] | 0.11 | 0.09 | 0.21 | 0.23 | — | 2.6 | 56 |
| Volume resistivity [×10⁻⁵ Ω·m] | 6 | 3 | 5 | 15 | — | 15 | — |

Examples 1 and 2 are compositions containing the components (A) to (E), and it was confirmed that both exhibited excellent storage stability and an excellent low temperature curing property of the cured product, and that a connection resistance value and volume resistivity, which are conductivity of the cured product, were also low.

In contrast, Comparative Example 1, which is a composition not containing the component (B), had a poor connection resistance value of the cured product, and the result was unsatisfactory in terms of conductivity of the cured product.

Comparative Example 2, which is a composition not containing the component (C), had a poor connection resistance value and poor volume resistivity of the cured product, and the result was also unsatisfactory in terms of conductivity of the cured product.

Comparative Example 3 is a composition in which the component (B)′, which is a solvent described in JP 2020-139020 A, is used instead of the component (B), and the component (B)′ dissolved the component (E), resulting in poor storage stability, and thus the measurements of a low temperature curing property, a connection resistance value, and volume resistivity were not performed.

Comparative Example 4 is a composition using only (d-1) as the component (D), and the results showed that a connection resistance value and volume resistivity, which are conductivity of the cured product, were poor.

Comparative Example 5 is a composition using only (d-2) as the component (D), and a connection resistance value of the cured product was more than 10 Ω, and conductivity of the cured product was poor, and thus volume resistivity was not measured.

### INDUSTRIAL APPLICABILITY

In recent years, metals such as nickel are often used for the housings of electric and electronic components. Such metals have a high connection resistance value, which leads to an increase in circuit resistance, but the connection resistance value can be reduced by using the cured product of the electroconductive resin composition of the present invention. Further, the electroconductive resin composition of the present invention also maintains storage stability, and thus the discharge amount does not change during long-term dispensing operations, and the short curing time can reduce damage to the adherend caused by heating. Due to these properties, the electroconductive resin composition of the present invention and the cured product thereof can be used to assemble various electric and electronic components, and the like, and may be deployed in a wide range of applications.

This application is based on Japanese Patent Application No. 2022-067364, filed on Apr. 15, 2022, the disclosure of which is incorporated by reference in its entirety.

1. An electroconductive resin composition comprising the following components (A) to (E), wherein an organic solvent content is 1% by mass or less with respect to the entire electroconductive resin composition,
component (A): an epoxy resin having two or more epoxy groups in one molecule,
component (B): a reactive diluting agent having one epoxy group in one molecule,
component (C): rubber particles,
component (D): electroconductive particles containing the following (d-1) and (d-2),
(d-1): plate-shaped silver particles,
(d-2): electroconductive particles other than plate-shaped silver particles, and
component (E): an epoxy curing agent.

2. The electroconductive resin composition according to claim 1, wherein the component (C) is core-shell particles.

3. The electroconductive resin composition according to claim 1, wherein an average particle size of the component (C) is 0.01 to 10 μm.

4. The electroconductive resin composition according to claim 1, wherein an average particle size of each of the (d-1) and the (d-2) is 0.1 to 30 μm.

5. The electroconductive resin composition according to claim 1, wherein the (d-1) and the (d-2) are silver powders surface-treated with stearic acid.

6. The electroconductive resin composition according to claim 1, wherein the (d-1) is single crystalline.

7. The electroconductive resin composition according to claim 1, wherein a mass ratio between the (d-1) and the (d-2) is (d-1):(d-2)=10:90 to 90:10.

8. The electroconductive resin composition according to claim 1, wherein the component (E) is an adduct-type latent curing agent.

9. The electroconductive resin composition according to claim 1, which is used on an adherend with an outermost surface being nickel.

10. A cured product formed by curing the electroconductive resin composition according to claim 1.
